(19) United States
(12) Patent Application Publication
(10) Pub. No.: US 2021/0057122 A1
(43) Pub. Date: Feb. 25, 2021

(54) DISPOSAL OF DEPLETED URANIUM PRODUCTS IN DEEP GEOLOGICAL FORMATIONS

(71) Applicant: Henry Crichlow, Norman, OK (US)

(72) Inventor: Henry Crichlow, Norman, OK (US)

(21) Appl. No.: 16/544,207

(22) Filed: Aug. 19, 2019

(51) Int. Cl. G21F 9/34; G21F 5/005

(52) U.S. Cl. CPC G21F 9/34; G21F 5/005

(57) ABSTRACT

The invention is of systems and methods for long-term disposal/storage of depleted uranium products and materials (such as munitions), in solid, liquid, and other physical forms in in lateral wellbores and/or in human-made caverns derived from a wellbore, located within deep geologic rock formations. Converted and/or modified depleted uranium products, materials, and/or wastes may be processed, made into slurries, chemically treated for long duration disposal, and/or implemented in waste disposal capsules and/or maintained as cementitious material or solids which are then transported and finally disposed of into lateral wellbores or human-made caverns within the deep geologic rock formations. Void space around depleted uranium products, materials, and/or wastes may be filled with a protective medium.

### TECHNICAL FIELD OF THE INVENTION

The present invention relates generally to the disposing of depleted uranium products and more particularly, the invention relates to (a) the disposal of munitions like depleted uranium penetrators and (b) the disposal of depleted uranium products like depleted uranium oxides and their derivatives.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Depleted uranium is formed as a byproduct in many industrial and military processes including; nuclear fuel manufacture operations, military weapons testing, and miscellaneous civilian, industrial, and military operations. For example, five to ten kilograms of depleted uranium are formed for every kilogram of low-enriched uranium that is produced for nuclear fuel systems. Depleted uranium material is a dangerous radioactive material that needs to be safely stored and/or disposed of.

The term depleted uranium penetrators refers to military munitions that may be referred to herein as “DUP.” The term “DUF” refers to the specific products of depleted uranium hexafluoride and/or their derivatives. The term “DUM” is a generic term herein referring to depleted uranium material in forms different from the depleted uranium penetrators (DUPs).

Today (circa 2019) there is a massive quantity of depleted uranium materials and waste products accumulating across the world. In the U.S. alone there are more than 70,000 metric tons (MT) of DUPs being stored in warehouses and in the open on the surface of the earth. Such surface operations are very costly, typically costing hundreds of millions of dollars annually. The DUPs consist of thousands of rounds of munitions which have been removed from operations by the military across the world.

In addition, there is a significant amount of dangerous radioactive uranium hexafluoride UF₆ which is a byproduct of the uranium enrichment industry. This DUF is accumulating in rusting steel cylinders across the U.S. and around the world. The current U.S. inventory is in excess of 700,000 MT of the material (NRC data). The world inventory is in excess of 1,200,000 MT. There is a significant need for new mechanisms and processes to safely get rid of (or minimize) the current surface storage operations of this dangerous radioactive waste and to sequester the DUP and/or DUF waste in a safe manner.

Regardless of the management alternatives used to safeguard the DUM at this time there is no clear answer as to the benefits of long-term surface storage or even storage in shallow pits or mined tunnels of the DUM. Currently, the only safe and scientifically valid approach is to remove the DUM from the surface or near surface disposal operations and sequester it in deep geological systems far from the ecosphere.

There are problems associated with prior art and their operations regarding storage and/or disposal of DUP and/or DUF.

In the case of DUP, the current systems and methods for disposal of the DUP on or near the surface pose serious environmental and technical problems which must be successfully addressed. The following issues which have been raised in public hearings and environmental discussions must be analyzed, addressed, and contingencies made to provide for safety to the environment and humankind:
(a) local and regional aquifer pollution problems in the case of leakage and filtration of surface and near surface waters;
(b) the solubility of DU penetrator metal with water, especially saline water;
(c) the reaction of the DU penetrator metal with moisture;
(d) the DU metal's overall disintegration over time;
(e) the swelling of the DU metal and subsequent change in volume;
(f) the spalling of the reacting DU metal at the surface from the rest of the DU metal body;
(g) in surface placement and storage, the associated settlement of the DU penetrator waste, along with surrounding backfill, and overlying cover system, with their potential resultant effects on site stability, infiltration and radon release;
(h) the generation of heat through the reaction of moisture with DU metal;
(i) the possibility for pyrophoric behavior by the DUP material;
(j) the formation of potentially explosive hydrogen (H₂) gas on the DU metal surface as it reacts;
(k) the presence of unexpected plutonium and other transuranic products in the compostion of the DU penetrator material;
(l) the long-term stewardship of DU penetrator and DUM wastes, including financial liability over a matter of decades; and/or the like.

In the case of the DUF there are also numerous problems which have yet to be overcome successfully before disposal of DUF can be considered safe and routine. DUF is very toxic. DUF can be a crystalline solid like rock salt. In storage cylinders the DUF may exist as solid salt at the bottom of the storage cylinder and a DUF gas above the solid phase at less than atmospheric pressure. DUF can react exothermically with air and moisture. To date, the problems to be resolved occur because the DUF is stored in surface or near surface facilities in tanks. The DUF treatment alternatives used today are:
(a) keep DUF in storage forever at the plants/facilities where produced;
(b) long-term consolidated storage as DUF (e.g., storage as DUF cylinders in yards, buildings, or a mine at a consolidated site);
(c) converting to oxides and keeping the converted products in storage in warehouses, below-ground vaults (but near surface), or a mine (near surface) at a consolidated site; and/or
(d) some very limited commercial use of the converted DUF material which include radiation shielding, dense material applications other than shielding, and light water reactor and advance reactor fuel cycles (there may be other esoteric/minor uses for DUF in industry, but the total volumes needed are small compared to the available depleted metal supply).

The similarity of DU to transuranic waste has recently been noted in a National Research Council (NRC) report, both regarding their radiological characteristics as well in regard to the difficulties that are associated with their disposal. See Table 1 below:

| Chemical Form | Specific Activity, nCi/gm |
|---|---|
| Uranium metal (DU) | 400 |
| Uranium dioxide (DUO2) | 350 |
| Uranium oxide (DU3O8) | 340 |
| Transuranic activity in TRU or GTCC waste | >100 |
| (Note 1 of NRC report) | |
| 0.2% uranium ore | 4 |

Table 1 shows that DU cannot (should not) be considered analogous to a naturally occurring uranium ore. DU is more analogous to a transuranic waste and this NRC report states: “If disposal [of depleted uranium oxide] is necessary, it is not likely to be simple. The alpha activity of DU is 200 to 300 nanocuries per gram. Geological disposal is required for transuranic waste with alpha activity above 100 nanocuries per gram.” (US National Research Council report.)

Regardless of the management alternatives used to safeguard the DUM at this time there is no clear answer as to the benefits of long-term surface storage or even storage in shallow pits or mined tunnels for the DUM. The only safe and scientifically valid approach is to remove the DUM from the surface or near surface disposal operations and sequester it in deep geological systems far from the ecosphere.

There is also a public safety and social issue problem, that is, the long-term stewardship of DUPs, DUF, and DUM wastes, including financial liability over a matter of decades or even centuries. Limiting this liability for future generations requires a means of disposal that is intergenerational as well as extremely long-term in its efficacy and reliability.

Based on the inherent shortcomings of the prior art, there exists a critical need for an effective, economical method for developing and utilizing an acceptable nuclear waste process for the depleted uranium nuclear waste products (such as DUPs, DUF, and/or DUM).

To solve the above-described problems, the present invention provides systems and/or methods to dispose of the depleted uranium products (such as DUPs, DUF, and/or DUM) currently accumulating on the earth's surface (and/or near surface) as a result of the activities stated above.

There is a long felt, but currently unmet, need for means, systems, and/or mechanisms that would allow the DU nuclear waste which exists in a variety of physical forms to be packaged and disposed of very deep within the earth's crust and in substantial quantities.

It is a requirement of this invention that the DU waste is sequestered in large enough volumes and at a considerable enough distance below the surface of the earth to maintain the highest level of safety as possible.

A need, therefore, exists for a new method for to safely dispose of DU wastes in a controlled manner and then depositing these wastes in a system that is designed to meet the requirements of public acceptance along with regulatory guidelines.

There is a need in the art for systems and methods that dispose of and/or store depleted uranium products (such as DUPs, DUF, and/or DUM) within deep geological formations significantly below the earth's surface.

The novel and non-obvious approaches as taught in this subject patent application provide systems and methodologies wherein (a) the DUP are disposed of after packaging and/or (b) the DUM disposal operations go either directly to the deep geological systems without conversion or after a conversion cycle the final DUM products are then disposed safely in the deep geological systems.

It is to these ends that the present invention has been developed.

### BRIEF SUMMARY OF THE INVENTION

To minimize the limitations in the prior art, and to minimize other limitations that will be apparent upon reading and understanding the present specification, various embodiments of the present invention may describe and define systems and methods for the long-term (over thousands of years) disposal/storage of DUP, DUF, and/or DUM: (a) in wellbores; (b) in well casing; (c) in capsules in well casings; (d) in capsules in well casings in wellbores; (e) in human-made caverns; (f) in capsules in human-made caverns—and wherein all such storage final disposal/storage locations are located within deep geological rock formations.

The present invention is concerned with disposing of nuclear waste and, more specifically, to methods and systems of disposing of depleted uranium products such as DUP, DUF, and/or DUM in deep underground rock formations using: (a) multilateral horizontal boreholes connected to the earth's surface by a vertical wellbore, and/or also, (b) the present invention also relates generally to the containment of hazardous DUP, DUF, and/or DUM wastes disposed within large human-made, subterranean cavities (caverns) in deep geologic formations.

The present invention relates generally to disposing of DUP, DUF, and/or DUM waste and more particularly, to: (a) the operations of DU waste disposal; and/or (b) utilization of lateral wellbores and specialized human-made caverns wherein the DU waste may be sequestered in caverns implemented in deep geologic formations, such that in both cases, the nuclear waste is disposed of safely, efficiently, economically and in addition, if required, may be retrieved for technical or operational reasons.

In some embodiments, this invention may comprise three interrelated and connected systems: (a) a nuclear waste capsule/container; (b) a specially designed wellbore; and/or (c) a deep geological cavern (which may be human made).

Methods of disposing nuclear waste (such as DUP, DUF, and/or DUM) in underground rock formations is disclosed by the present invention. In some embodiments, such a method may comprise a step of selecting an area of land having a rock formation positioned therebelow. The rock formation must be of a depth able to prevent radioactive material placed therein from reaching the surface over geologic times and must be at least a predetermined distance from active water sources for human activity. In some embodiments, such a method may further comprise drilling a vertical wellbore from 5,000 feet to 30,000 feet deep from the earth's surface of the selected area which extends into the given underground rock formation. In some embodiments, a diameter of the vertical wellbore may be between 10 inches and 48 inches.

The selected geologic formations should also be structurally closed and comprise sufficient distinct geologic layers of specific petrophysical properties such that the repository is stratigraphically impermeable to fluid migration out of the zone. This rock property may limit radionuclide migration away from the given underground storage area or zone.

In some embodiments, at least one primary horizontal lateral wellbore of length varying from 500 feet to 20,000 feet, may be drilled out from the (primary) vertical wellbore whereby the surface of the horizontal lateral is defined by the underground rock formation. In some embodiments, a diameter of the lateral wellbores may be from 5 in to 30 inches (in). In some embodiments, secondary lateral wellbores may be drilled off the initial primary lateral wellbore as needed to increase the total volumetric capacity of the disposal system. In some embodiments, a steel (or steel like) casing may be placed within the horizontal lateral wellbore(s) and cemented in place by circulating cement in the annular space between the steel casing and the wall of the given wellbore.

In some embodiments, DU nuclear waste may be stored in a container or capsule and the encapsulated nuclear waste may be positioned within the horizontal lateral wellbore(s) as described herein. In some embodiments, the capsules/containers (with the DU) may then be sealed in place with appropriate means.

In some embodiments, DU nuclear waste may be stored in a deep human-made caverns. In some embodiments, the human-made cavern may be located within a deep geological rock structure/formation. By enlarging a pilot wellbore by under-reaming (or the like) to a significant and predetermined diameter and continuing to drill-out the cavity/cavern from 500 feet up to 10,000 feet, this operation may produce a permanent human-made cavity/cavern for waste disposal. A geologic human-made cavern of this size can provide more than 1,500,000 gallons of liquid waste storage or about 200,000 cubic feet of volumetric storage.

Briefly, one aspect of the disposal method in accordance with this invention achieves the intended objectives by including the steps of: drilling a pilot well which intersects a deep geologic rock formation. The creation of a human-made cavern/cavity, by under-reaming processes from a vertical and/or lateral wellbore, can be designed to allow the geometry and location of the human-made cavern/cavity to be controlled so that the life of the human-made cavern/cavity is a safe repository for nuclear waste.

In some embodiments, methods of the present invention may provide an operational method for fabricating at least one DU waste capsule/container. In this operational method, the tasks involved provide a more efficient methodology to allow safer, more economical, and long-lasting disposal of the DU waste in the deep underground repositories.

The eventual degradation of the physical integrity of well bore system components should be considered and addressed with respect long-term nuclear waste disposal and/or storage. Some mechanisms and/or means are needed to minimize, reduce, and/or mitigate such degradation. A long-lived technology system may be required to guarantee within technical certainty that DUP, DUF, and/or DUM may be safely contained within and/or adjacent to the given geological repository zone.

Means may be utilized that provide for very long-lived protection from degradation and migration of material away from the nuclear waste material. Stratigraphic and current structural geological analysis of underground oil formations which have historically produced heavy oil and other hydrocarbons indicate that tar-like deposits have existed for millions of years and have remained essentially unchanged and intact over such long time periods. In many cases such tar-like deposits actually formed an impermeable seal that prevented fluid flow across a rock matrix due to physical and chemical changes in the rock media.

Bitumen-like products and some petroleum-based products possess the qualities that make them capable of being utilized for low temperature sealing situations in the disposal of nuclear wastes. Other higher temperature resistant chemical products may be needed for higher temperature situations.

In many oil reservoirs, geologists have defined so-called “marker” beds of tar or high viscosity bitumen which are millions of years old. This geologic phenomenon illustrates the chemical stability of the hydrocarbon-based material over very long time periods, often of millions of years. This chemical stability of the tar-like material allows a selection of natural or similar synthetic hydrocarbons or hydrocarbon derivatives-based materials as the long-lived high-temperature resistant layer used to surround DU waste materials inside waste receiving capsules/containers. This patent application may provide for the use of such a protective medium in the protection of the DU material, protection of the nuclear waste components, and/or in the protection of the environment from the DU material.

The current invention may teach an improved engineered barrier system implemented with a longest duration barrier, the protective medium, at the inner-most layer of protection. In a naturally occurring degradation process, the degradation beginning at the outermost layer in contact with the earth (rock formation) continues inwards into the central core of the nuclear waste disposal system. The outer protective layers, outer cement, outer casing pipe (e.g., of steel), inner cement, inner pipe (e.g., of steel), all may degrade over varying time periods. The inner-most tar-like protective medium has been historically demonstrated in the geological record, to be an effective fluid and migration barrier for millions of years. In numerical terms the cement and steel (or steel like compositions) may degrade in 2,000 to 10,000 years, however the tar or tar like protective medium encasing a central core may protect the core for hundreds of thousands of years or more.

This invention specifically addresses the following technical consideration: the waste capsule/container may provide short-term protection, such as, up to 10,000 years. Long-term protection of the nuclear waste forms from the ecosphere may depend in part on the physical properties of the deep geological repository.

An object of the present invention may be to provide a method and/or a system of disposing of nuclear waste in the form of DUP, DUF, and/or DUM in deep underground rock formations.

An additional object of the present invention may be to provide a method and/or a system of disposing of nuclear waste (such as, DUP, DUF, and/or DUM) in deep underground rock formations which may in turn provide protection in case of rupturing or leaking of the nuclear waste containing capsules/containers.

An additional object of the present invention may be to provide a method of disposing of DU nuclear waste in capsules/containers which would minimize the physical and chemical degradation of the waste material for a sufficiently long period of time in the geological environment.

An additional object of the present invention may be to provide a method and/or a system wherein the nuclear waste containing capsules/container may be easily placed, located, dispersed, or “landed” in the wellbores or caverns (including human-made caverns) as a linear string of connected elements (e.g., a linear string of connected capsules/containers).

An additional object of the present invention may be to provide a method and/or a system wherein the nuclear waste containing capsules/containers may be rapidly landed or deployed in the wellbore laterals or caverns (including human-made caverns) without a need for a major operation at the wellsite.

An additional object of the present invention may be to provide a method and/or a system of disposing of DU nuclear waste in deep underground rock formations which may provide for retrieval at some future date less than 100 years.

It is another object of the invention to provide a method and/or a system of the type described wherein a human-made cavern of substantial strength and durability, with sufficiently protective walls and volumetric capacity can be formed in a deep geologic formation being several thousand feet below the earth's surface and wherein the human-made cavern can be several thousand feet in vertical extent with a large diameter ranging from two feet to as much as ten feet.

It is yet another objective of the present invention to utilize a tar, tar-like, bitumen, bitumen-like material as a protective medium surrounding the DU waste material.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A is a schematic cross-section showing an example of a typical U.S. military armor piercing depleted uranium round (e.g., a 120 mm sized round).

FIG. 1B, a partial cut-away perspective view, is a schematic showing an example of a type of military DU penetrator (DUP) device. FIG. 1B shows the complete projectile, the kinetic element, the tracer element and fin stabilizers.

FIG. 1C is a schematic showing the depleted uranium (DU) kinetic element isolated and separated from the rest of the DUP. (This kinetic element is the main destructive part of the projectile.)

FIG. 1D is a schematic showing an external view of the stackable steel cylinders or drums into which DUF may be stored by stacking on or near the earth's surface.

FIG. 1E is a schematic showing an external view of a rusted and/or deteriorating steel cylinder or drum into which the DUF may be stored and stacked on or near the earth's surface.

FIG. 2A shows a schematic cross-section of a DUP nuclear waste storage system illustrating DUP objects being stored/disposed within a waste capsule/container, containing the protective medium, wherein this waste capsule/container may within a lateral wellbore.

FIG. 2B shows a schematic cross-section showing perspective of a capsule/container with multiple DUP devices stored vertically within the capsule/container.

FIG. 2C shows a schematic cross-section of a capsule with solid DUM derived waste product inside the waste capsule/container.

FIG. 2D shows the cross-section of a capsule/container with end couplings, the capsule/container may be inside a portion of a disposal lateral wellbore.

FIG. 3A shows a schematic longitudinal cross-section showing a portion of the lateral wellbore with waste capsules/container in place containing DUP and/or DUM waste.

FIG. 3B shows a schematic longitudinal cross-section showing a portion of the lateral wellbore containing DUM disposed by pumping the DUM material (before curing/hardening) into and inside of the given wellbore casing.

FIG. 4A shows a schematic of a vertical cross-section of a human-made storage cavern in the deep geologic formation(s), wherein the human-made cavern may be partially filled with DU waste containing capsules/containers.

FIG. 4B shows a schematic of a vertical cross-section of a human-made storage cavern in the deep geologic formation(s), wherein the human-made cavern may be partially filled with cementitious DU waste material or solid aggregate form DU waste.

FIG. 4C shows a schematic of a vertical cross-section of a human-made storage cavern in the deep geologic formation(s), wherein the human-made cavern may be partially filled with a supernatant medium in which the DU waste containing capsules or DU solid nuclear waste materials may be immersed and/or dispersed in.

FIG. 4D shows a schematic of a vertical cross-section of a suite of multiple human-made storage caverns, wherein each such human-made cavern in the suite may contain DU waste, wherein this suite of human-made caverns may greatly increase the disposal of DU waste quantities from a single wellhead site/location.

FIG. 5A is a flow chart illustrating decision-making processes in the systems and/or the methods utilized by various embodiments of the present invention.

FIG. 5B is a flow chart illustrating various steps in the process (method) of disposing of DUP, DUF, and/or DUM waste in lateral wellbores and/or human-made caverns in deep geologic formations.

FIG. 6 is a graph showing volumetric capacity in gallons for human-made cavities varying in length from 1,000 feet to 10,000 feet and varying diameters from 12 inches (in) to 60 inches (in).

### REFERENCE NUMERICAL SCHEDULE

3 DU armor piercing round 3
4 propellant 4
5 primer 5
6 remote surface storage location of DU waste 6
7 wellsite support buildings/structure 7
8 Earth surface 8
9 drilling rig 9
10 sabot body 10
11 fin stabilizers 11
12 DU kinetic element 12
12a length of kinetic element 12a
12b diameter of kinetic element 12b
13 tracer element 13
14 clean steel storage cylinders for DUF storage on the surface 14
14a length of steel cylinder 14a
14b diameter of steel cylinder 14b
15 rusted steel storage cylinders for DUF storage on the surface 15
15a rust 15a
16 DU waste capsule/container 16
17 divider/support 17
18 long-term protective medium 18
19a medium 19a
19b cement 19b
20 casing (pipe) 20
21 centralizer 21
22 wellbore plug 22
23 deep geological rock formation 23 (host rock 23)
24 coupling 24
24a nipple 24a
25 vertical or lateral wellbore section 25
26 lateral or S-shaped wellbore section 26
27 human-made cavern 27
28 waste DUM (in human-made cavern) 28
28a solid or cementitious waste DUM (in wellbore or in capsule) 28a
28b supernatant medium (in cavern immersing and surrounding waste) 28b
100 description of the DUP disposal/storage system 100
200 description of the DUM disposal/storage system 200
300 method of DUP disposal/storage 300
400 method of DUM disposal/storage 400
500 method of DUM immobilization 500
600 description of DU disposal/storage system 600
610 DUP(s) 610
620 DUP encapsulation and packaging 620
630 lateral wellbore(s) 630
640 cavern(s) 640
645 seal 645
650 DUM 650
660 DUM cementitious material 660
670 DUM encapsulation and packaging 670
680 lateral wellbore(s) 680
690 cavern(s) 690
695 seal 695
700 method of DU storage/disposal 700
701 step of collecting DUPs 701
702 step of preparing and packaging the DUP elements 702
703 step of modifying and/or incorporating protections 703
704 step of building capsules/containers string 704
705 step of emplacing storage/disposal capsule/container 705
706 step of emplacing storage/disposal capsule/container in lateral wellbore(s) 706
707 step of emplacing storage/disposal capsule/container in deep caverns 707
708 step of sealing lateral wellbore(s) and/or step of sealing cavern(s) 708
709 step of collecting DUM 709
710 step of making cementitious slurry 710
711 step of modifying slurry 711
712 step of pumping slurry 712
713 step of pumping slurry into lateral wellbore(s) 713
714 step of pumping slurry into deep caverns and adding supernatant 714
715 step of sealing lateral wellbore(s) and/or step of sealing cavern(s) 715
716 step of modifying and/or converting DUF to derivative solids 716
717 step of immobilizing converted solids 717
718 step of packing immobilized DU solids 718
719 step of encapsulating immobilized DU solids 719
720 step of emplacing waste DU 720
721 step of emplacing waste DU 721
722 step of emplacing waste DU 722
723 step of sealing wellbore laterals and/or sealing deep caverns 723

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

The novel and non-obvious features which are considered characteristic for embodiments of the present invention are set forth in the appended claims. Embodiments of the present invention itself, however, both as to construction and methods of operation, together with additional objects and advantages thereof, will be best understood from the following description of the specific embodiments when read and understood in connection with the accompanying drawings. Attention is called to the fact, however, that the drawings are illustrative only, and that changes may be made in the specific construction illustrated and described within the scope of the appended claims.

Notes on some terminology used herein: The term depleted uranium penetrators refers to military munitions that may be referred to herein as “DUP.” The term “DUF” refers to the specific products of depleted uranium hexafluoride and their derivatives. The term “DUM” is a generic term herein referring to “depleted uranium material” in forms different from the depleted uranium penetrators (DUPs). And the term “DU” may refer to depleted uranium. In this patent application the words “capsule” and “container” may be used interchangeably with the same meaning.

In this patent application the terms nuclear waste and radioactive waste describing high-level nuclear waste may also be used interchangeably herein. In addition, the term waste generally means nuclear or radioactive waste in general, and DU waste in particular, or waste derived from DU.

In this patent application the terms “well” and “wellbore” may be used interchangeably and refer to cylindrical elements implemented in design and/or installation processes of some embodiments of the present invention. In addition, the term “ream” and “under-ream” may be used interchangeably to mean the enlarging of a wellbore or hole in a rock medium, that may then result in the formation of a human-made cavern.

In this patent application the terms “cavern,” and “cavity” may be used interchangeably with the same meaning.

In addition, “matrix rock” and “host rock” may be used interchangeably.

Note, unless an explicit reference of “vertical wellbore” or “lateral wellbore” (i.e., “horizontal wellbore”) accompanies “wellbore,” use of “wellbore” herein without such explicit reference may refer to vertical wellbores or lateral wellbores, or both vertical and lateral wellbores. “Laterals” may refer to lateral wellbores.

In some embodiments, a method may provide an operational process for long-term disposal/storage of DUP, DUF, and/or DUM. Such methods may provide for more efficient methodology to allow safer, more economical, and long-lasting disposal/storage of DUP, DUF, and/or DUM waste in deep underground lateral wellbores and/or human-made caverns.

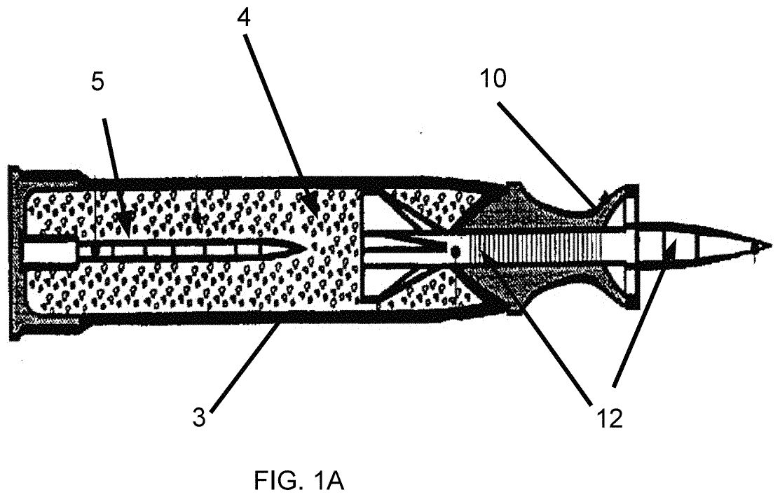

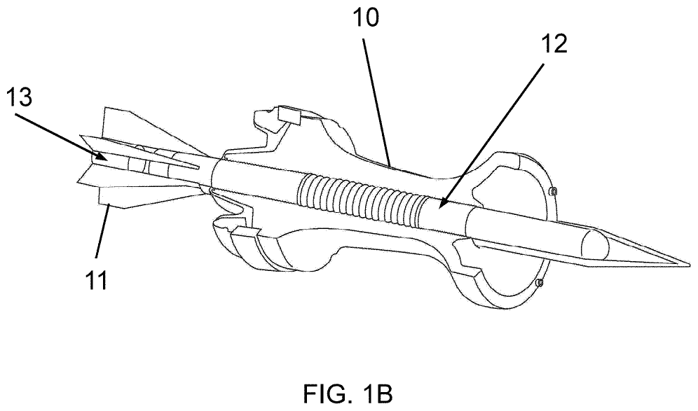

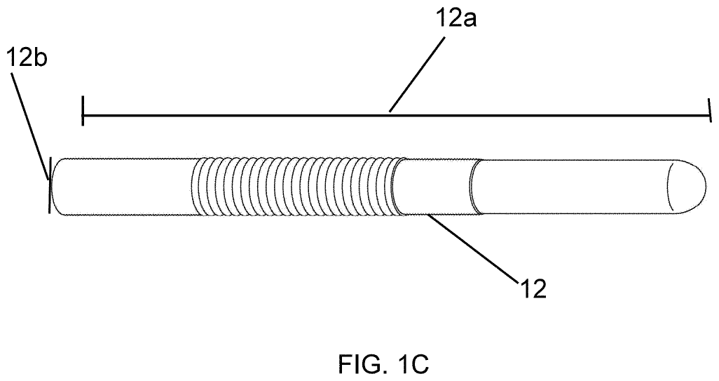

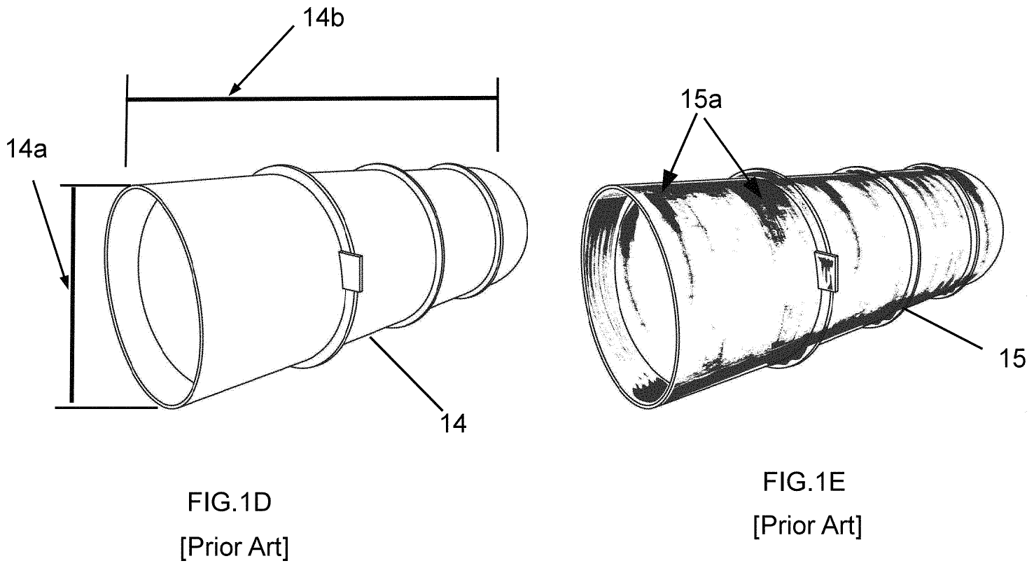

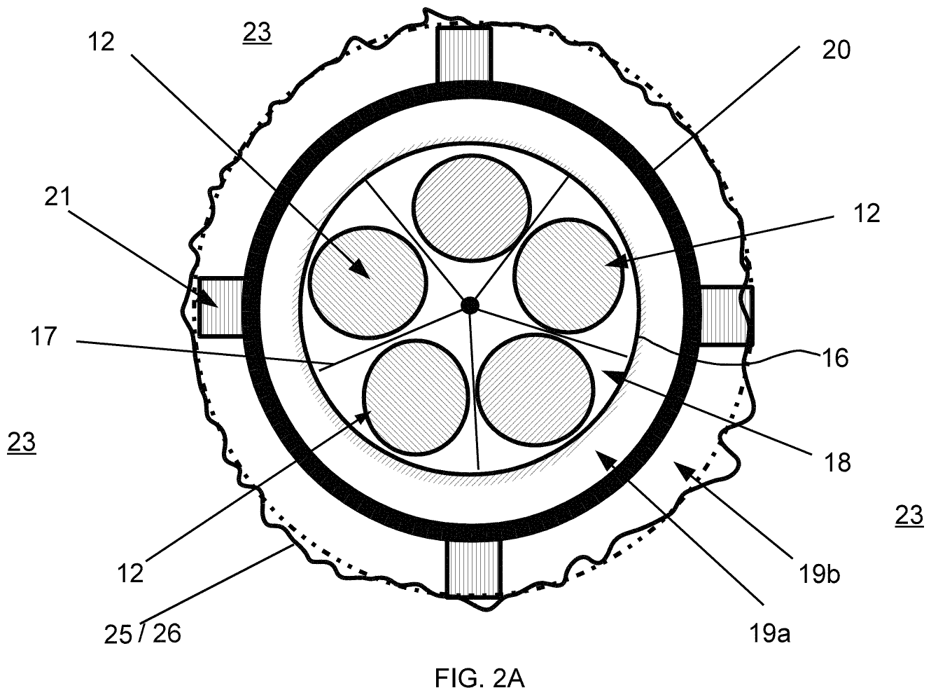

FIG. 1A is a schematic cross-section showing an example of a typical U.S. military DU (depleted uranium) armor piercing round (munition) 3 (e.g., a 120 mm sized round or other sized round). A given DU armor piercing round 3 may comprise: a DU kinetic element 12, propellant 4 to accelerate DU kinetic element 12, primer 5 to activate/initiate propellant 4, and a sabot body 10 (or the like body). Sabot body 10 may be a “jettison-able” shell. DU kinetic element 12 may also be known as the penetrator. DU armor piercing rounds 3 may vary in size; e.g., from 20 mm to 120 mm in diameter and the given DU armor piercing rounds 3 may contain a fraction of a kilogram (kg) of DU up to 4 kg of DU.

FIG. 1B may illustrate a portion of a typical DU armor piercing round 3 (without the round casing, propellant 4, and primer 5). DU armor piercing round 3 may have fin stabilizes 11 for flight stability. DU armor piercing round 3 may have a trace element 13 to aid in targeting. DU kinetic element 12 is constructed from DU and is very high density facilitating the ability of DU kinetic element 12 to “penetrate” some armor when of sufficient velocity and mass. DU kinetic element 12 is a nuclear waste product and as such needs to be disposed of safely and securely for a very long time. DUPs are available in several different sizes depending on the end use of the munitions. Large quantities of these DUPs have accumulated around the world. The DU kinetic elements 12 because of their cylindrical shape may be packaged in groups to allow a cylindrical waste disposal/storage capsule system to efficiently dispose of a large quantity of DUPs effectively and compactly inside a wellbore 25 or inside a human-made cavern 27.

FIG. 1C may illustrate the DU kinetic element 12 of the DUP shown in FIG. 1A or FIG. 1B. Sometimes a given DU kinetic element 12 may a substantially solid uranium metal rod as shown in FIG. 1C. The cylindrical shape of DU kinetic element 12 lends itself to efficient storage and packaging in capsules 16 as taught in this subject patent application. A given DU kinetic element 12 may have a fixed and predetermined length 12a. A given DU kinetic element 12 may have a fixed and predetermined diameter 12b.

FIG. 1D may show a steel storage cylinder (or drum) 14 as conventionally used in storage and disposal of DUF on or near the earth's surface today. That is, steel storage cylinder 14 is prior art. A given steel storage cylinder 14 may be about 12 feet long, 4 feet in diameter, and weigh about 14 tons. The steel wall thickness is about 5/16 inch. Thousands of these steel storage cylinder 14 are stacked like “cord wood” in rows, two or three cylinders high, usually on a gravel base or in a warehouse at several locations around the world, at or near the earth's surface. In such surface storage locations and conditions, steel storage cylinders 14 are susceptible to the elements, moisture, air, oxidation, corrosive gases, and security threats. A given steel storage cylinder 14 may have a fixed and predetermined length 14a. A given steel storage cylinder 14 may have a fixed and predetermined base diameter 14b.

FIG. 1E may show a rusted and/or deteriorating steel cylinder 15 as conventionally used in storage and disposal of DUF on or near the earth's surface. Note, rusted and/or deteriorating steel cylinder 15 is prior art. FIG. 1E shows rust 15a on the rusted and/or deteriorating steel cylinder 15. In several published reports, the cylinders 15 exteriors are shown to have rusted and are rapidly deteriorating because of moisture, ground contamination, polluted air, oxidation, and/or other ambient problems. Moving these rusted and/or deteriorating steel cylinder 15 is a dangerous and critical issue which can lead to breakage and leakage of DUF.

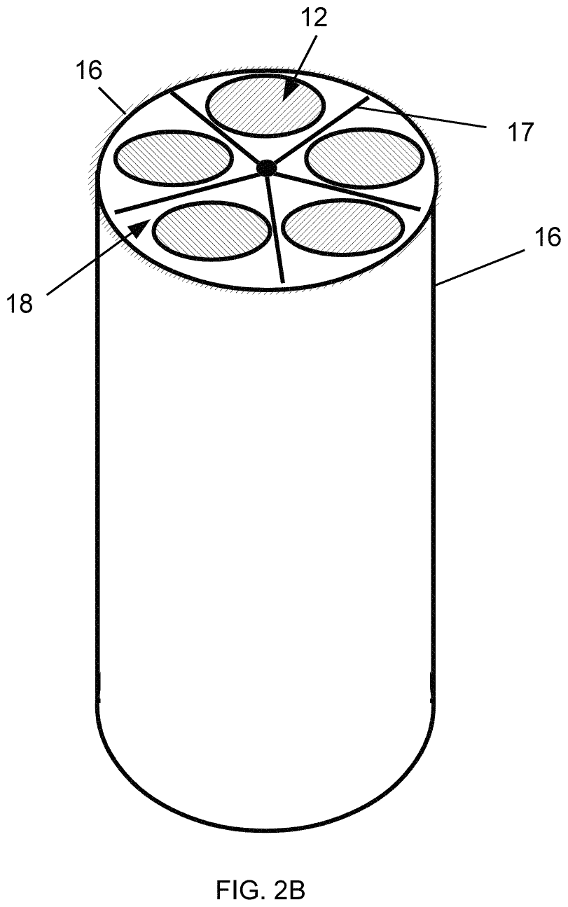

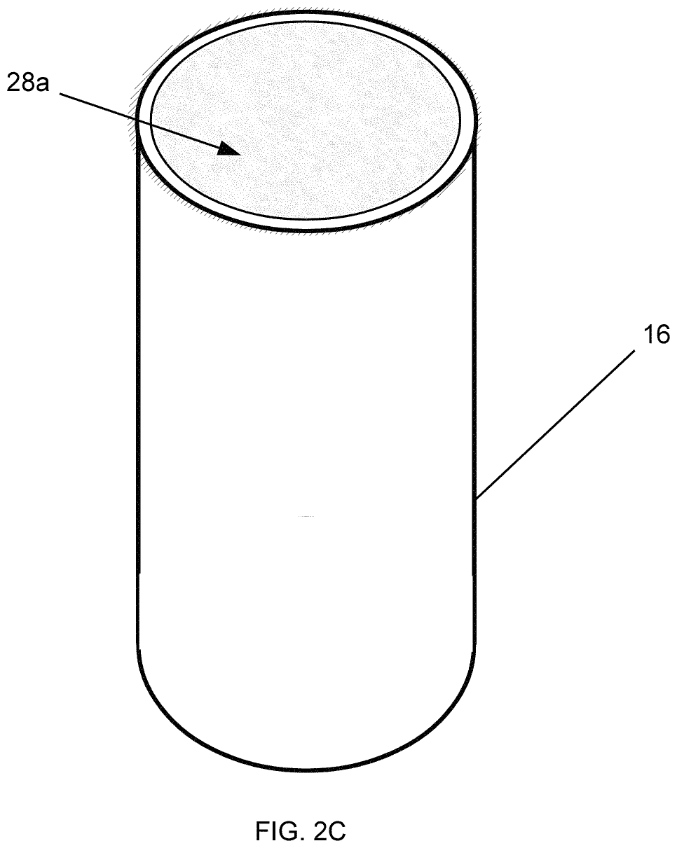

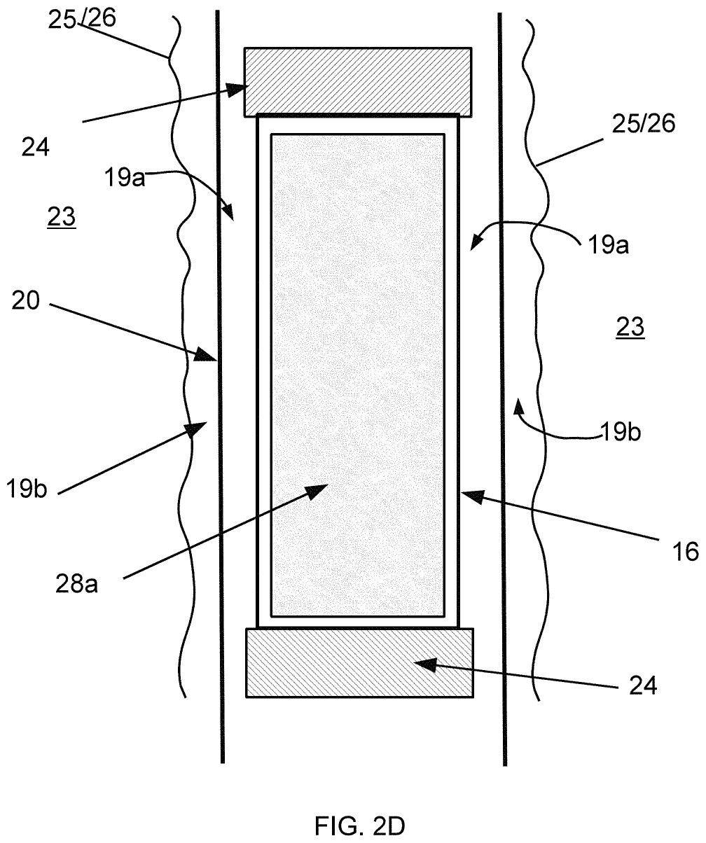

FIG. 2A which is not shown to scale, may illustrate a cross-sectional view of the packaging of DU kinetic elements 12 in a capsule 16. Some embodiments, contemplated herein may contemplate at least one capsule 16.

In some embodiments, at least one capsule 16 may be configured for receiving DU within the at least one capsule 16; wherein the at least one capsule 16 may be sealable.

In some embodiments, the at least one capsule 16 may be a substantially cylindrical member of a length and of a diameter that are both fixed (non-variable) and finite (predetermined); wherein the at least one capsule 16 may be comprised of a side-wall and opposing terminal ends that form the substantially cylindrical member; wherein the opposing terminal ends seal the at least one capsule 16. See e.g., FIG. 2A, FIG. 2B, FIG. 2C, and FIG. 2D. In some embodiments, the at least one capsule 16 may be resealable.

In some embodiments, the at least one capsule 16 may comprise an exterior that may be substantially constructed of one or more of: a metal, a plastic, a composite, or a ceramic. In some embodiments, the metal may be selected from one or more of: steel, copper, or lead.

In some embodiments, DU kinetic elements 12 may be “circle packed” inside capsule 16. In some embodiments, DU kinetic elements 12 may be disposed in capsule 16 and may be separated and held in place by supports 17. In some embodiments, supports 17 may be known as dividers 17, and/or may function as a divider or dividers, separating one DU kinetic elements 12 from another DU kinetic element 12 within a given capsule 16. In some embodiments, supports 17 may be structural members.

In some embodiments, when the at least one divider 17 may be inserted into the at least one capsule 16, the at least one divider 17 may subdivide an internal volume of the at least one capsule 16 into a predetermined quantity of two or more sub-internal volumes of the at least one capsule 16; wherein each sub-internal volume of the at least one capsule 16 may be configured to receive at least some DU. In some embodiments, the at least one divider 17 may facilitate various “circle packing” schemes, see e.g., FIG. 2A. In some embodiments, when the at least one divider 17 may be inserted into the at least one capsule 16, this at least one divider 17 may provide structural reinforcing support to the at least one capsule 16.

In some embodiments, a protective medium 18 may be placed inside capsule 16 walls and may fill void space and surround the DU kinetic elements 12. In some embodiments, protective medium 18 may be used in a variety of forms, ranging from semi-solid, moderately viscous substances, to slurries to liquids or even in some cases powders. In some embodiments, protective medium 18 may be selected from one or more of the following: tar, tar-like, bitumen, bitumen-like, asphalt, asphalt-like, heavy hydrocarbons, heavy oils, synthetic compounds, bentonite clays, vermiculite clays, modified clay nanotube compounds or their derivatives, combinations thereof, and/or similar hydrocarbon system. Protective medium 18 may afford long term protection as in the case of tars and their derivatives. Protective medium 18 may also include biocides. Protective medium 18 may also include anti-corrosion products/agents. Protective medium 18 may also include clay material like treated bentonites, treated vermiculites, and/or combinations thereof.

In some embodiments, protective medium 18 may be configured for minimizing degradation of the at least one capsule 16 from radiation emitted by the DU.

In some embodiments, protective medium 18 may be heated from about 80 degrees Celsius to about 195 degrees Celsius before inclusion in capsule 16 to destroy or “pasteurize” protective medium 18 by destroying or killing microbes and fungi that may be present in protective medium 18. The destruction or killing microbes and fungi may prevent future microbial degradation of protective medium 18 by microorganisms that may be naturally or inadvertently present in protective medium 18. In some embodiments, a biocide may be used to treat protective medium 18 to kill the destructive microbes (and fungi). This possible microbial degradation can lower the long-time effectiveness of protective medium 18 which is expected to protect contents of capsule 16 for up to 10,000 years or more.

It is further noted that the protective medium 18 may be an anoxic and/or an anaerobic medium. In some embodiments, capsule 16 and its contents may be purged with nitrogen to remove any air before the packaging process with protective medium 18 is complete. In such a case, specific oxygen scavengers and/or other corrosion retarding compounds may be included in protective medium 18.

In some embodiments, the system may further comprise a gas blanket. In some embodiments, the gas blanket may substantially fill in void space around the DU that is within the at least one capsule 16 to minimize a presence of oxygen in the at least one capsule 16. In some embodiments, the blanket gas may purge (push out) oxidizing gasses, such as oxygen present in air within the at least one capsule 16. In some embodiments, a gas for use in the gas blanket may be an inert gas or a substantially inert gas. In some embodiments, a gas for use in the gas blanket may be nitrogen gas.

In other embodiments the void space around DU kinetic elements 12 in capsule 16 may be filled with protective liquids and/or slurries containing selected oxygen (O₂) scavenging agents and/or corrosion resistant agents. The oxygen scavengers may be organic, inorganic, and/or combinations thereof. The oxygen scavengers may be selected from the following: a sulfite compound, sodium sulfite, sodium bisulfite, ammonium sulfite, ammonium bisulfite, sodium meta-bisulfite, potassium sulfite, potassium bisulfite, potassium meta-bisulfite, calcium sulfite, calcium hydrogen sulfite, and/or combinations thereof. Commercially available brands of oxygen scavengers and/or corrosion inhibitors include: NOXYGEN™, AMI-TEC™, KD700™, and KD40™. In some embodiments, these oxygen scavengers and/or corrosion inhibitors may be added in the range of at least 0.1 gallon per 100 barrels to 500 barrels of liquids. The actual usage amount may vary with the oxygen concentration in the selected medium. In some embodiments, a film-coating inhibitor may be used to help protect DU kinetic elements 12 from corrosion. This combination of protective agents reduces the presence of oxidizing ions which decrease the tendency of DU kinetic elements 12 to corrode, degrade, deteriorate, and/or disintegrate. In some embodiments, protective medium 18 may include oxygen scavengers.

In some embodiments, void space around DU kinetic elements 12 in capsule 16 may be filled by other materials which can lower radionuclide migration or slow down capsule 16 and DU kinetic elements 12 degradation/corrosion. It is possible and contemplated in this patent application to store a large, but finite, fixed, and predetermined quantity of DU kinetic elements 12 inside a given capsule 16 depending on the radial dimensions and length of the given capsule 16. In some embodiments, contemplated sizes of capsule 16 may be fixed and predetermined, but may be from 5 inches in diameter to 24 inches in diameter. In other embodiments, capsule 16 have other fixed and predetermined diameters.

Efficient volumetric packing of DU kinetic elements 12 within a given capsule 16 may be possible using available packaging methods well known in the packaging industry. Further elements shown in the FIG. 2A include: outer casing (pipe) 20 (which may be substantially constructed from steel or a steel like material); a plurality of centralizers 21 which make casing 20 “standoff” from the walls of the wellbore 25 and in between which cement 19b may be circulated and positioned as a physical and structural support and a protective system between capsule 16 and casing 20 and/or between casing 20 and deep geological rock formation 23 (host rock 23). In some embodiments, centralizers 21 may function as spacers, to keep casing 20 approximately concentric within wellbore 25. In some embodiments, cement 19b may be oilfield cement or the like.

In some embodiments, cement 19b may be a filler. In some embodiments, this filler (such as, but not limited, cement 19b), may substantially fill in space between an exterior of casing 20 and an interior of the at least one wellbore 25/26. See e.g., FIG. 2A.

Continuing discussing FIG. 2A, in some embodiments, casing 20 may have an annular (concentric) relationship with respect to capsule 16 and with respect to wellbore 25/26, see e.g., FIG. 2A. In some embodiments, each capsule 16 within wellbore 25/26 may have a casing 20 concentrically surrounding the given capsule 16. In some embodiments, casing 20 may be substantially constructed from a steel and/or a substantially steel like material.

Continuing discussing FIG. 2A, in some embodiments, a centralizer 21 may be disposed within the at least one wellbore 25/26, exterior to the at least one capsule 16, wherein centralizer 21 may be configured to keep the at least one capsule 16 substantially concentrically located within the at least one wellbore 25/26. In some embodiments, centralizer 21 may be disposed within the at least one wellbore 25/26, exterior to casing 20, wherein centralizer 21 may be configured to keep casing 20 (capsule 16 in some embodiments) substantially concentrically located within the at least one wellbore 25/26. See e.g., FIG. 2A. In some embodiments, the systems and/or methods described herein, may comprise at least three centralizes 21, substantially equal distant spaced around capsule 16. In some embodiments, the systems and/or methods described herein, may comprise four centralizes 21, substantially equal distant spaced around capsule 16, see e.g., FIG. 2A.

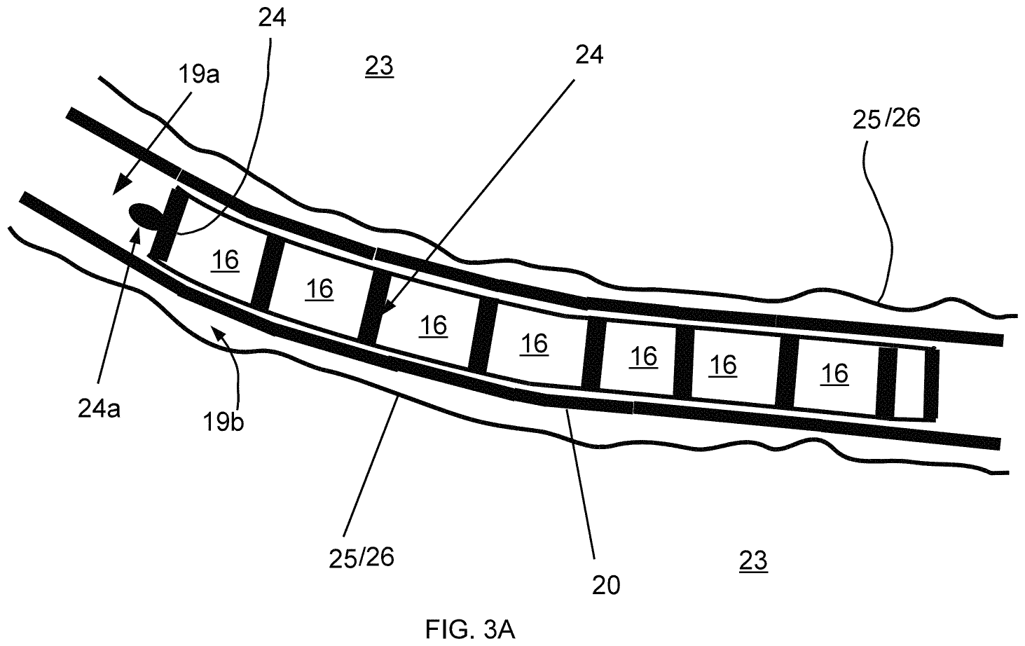

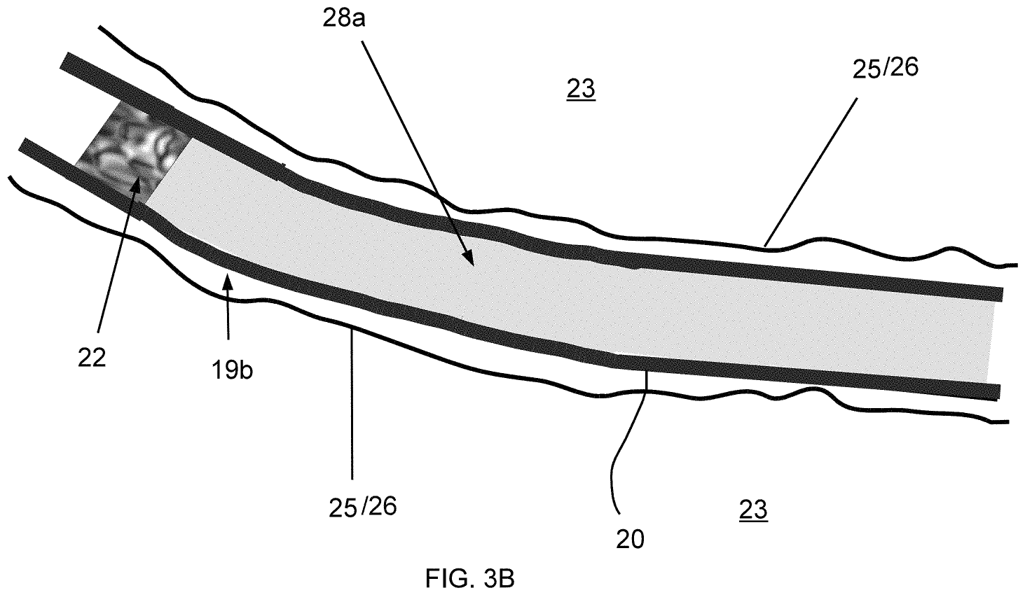

In some embodiments, capsule 16 body may be substantially constructed of structural steel or a similar metal. In this type of capsule 16 construction, multiple waste capsules 16 may form part of a chain of capsules 16 that are joined by couplings 24 to form a string (see e.g., FIG. 3A). In this embodiment the structural steel may be necessary and/or desired, since capsule 16 body may be subjected to large tensile loads when the multiple-capsule 16 string is inserted into the wellbores 25 for the long-term disposal/storage of the DU waste.

In some embodiments, medium 19a may be protective. In some embodiments, medium 19a may be a filler. In some embodiments, this filler (medium 19a) may substantially fill in space between an interior of casing 20 and an exterior of the at least one capsule 16. In some embodiments, medium 19a may be drilling mud material or the like. In some embodiments, medium 19a may be comprised of specialized drilling mud or bentonites-like compounds if the disposal is intended as temporary (e.g., intended as less than permanent); or if the waste capsules/container 16 is expected to be retrieved after a reasonably short time, such as, but not limited to, 100 years. If the disposal process is intended as permanent, then medium 19a may be similar (or substantially similar) to cement 19b which may be intended as a permanent cement.

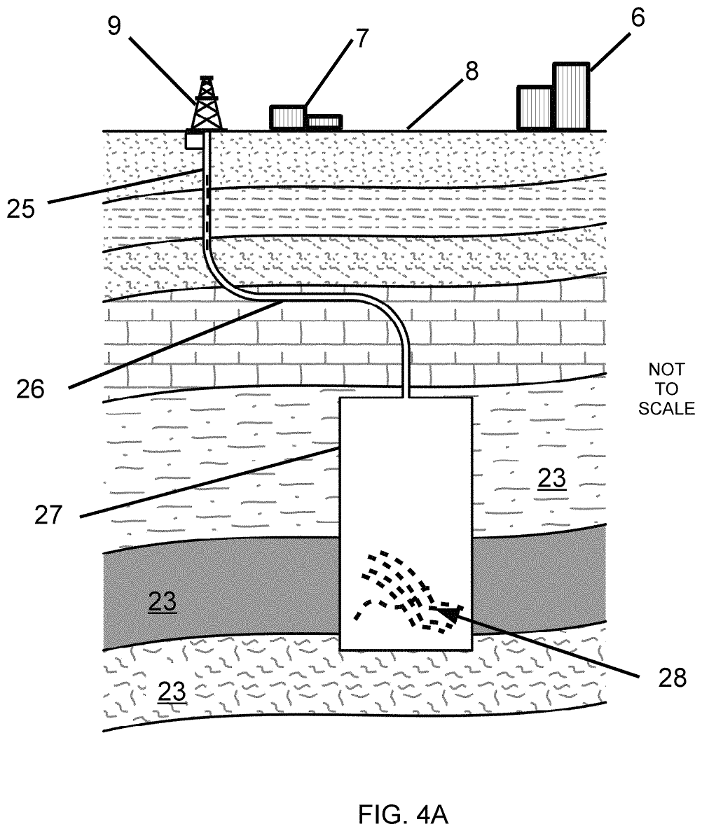

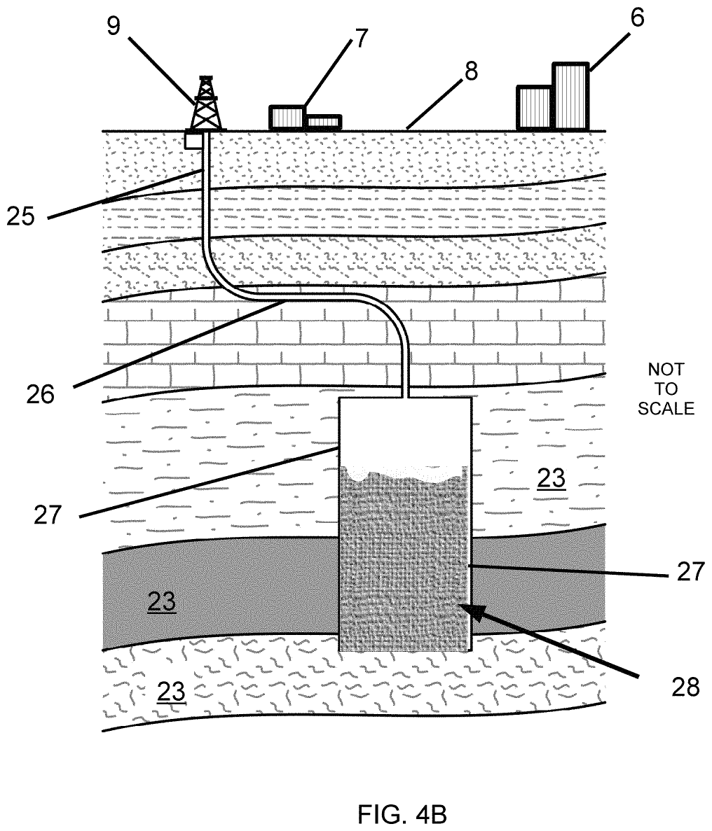

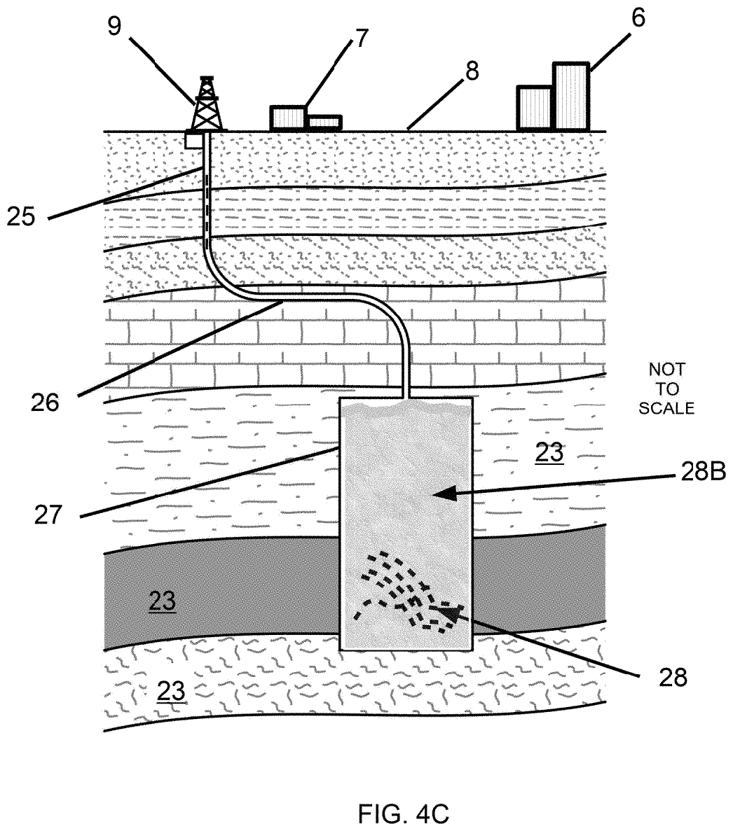

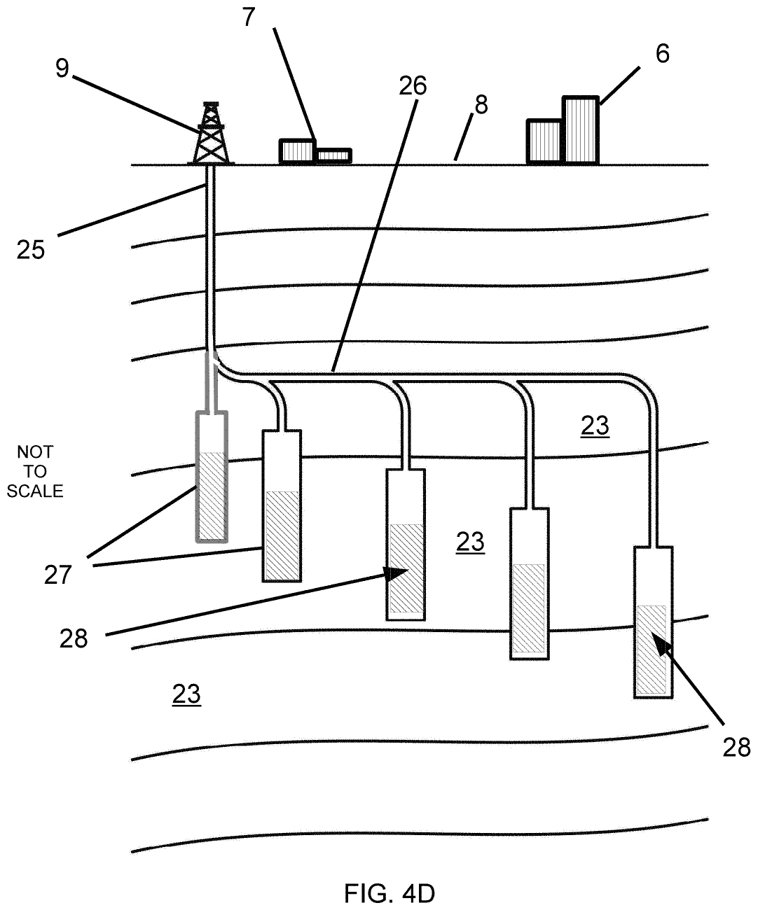

In an alternative embodiment, capsule 16 may be used primarily as a transport device in which the DU is transported from the earth's surface 8 (see e.g., FIG. 4A) and delivered into the human-made cavern(s) 27 (see e.g., FIG. 4A) or the lateral wellbore 25. In this embodiment, the DU material is not expected to be retrieved and disposal is considered final. In this alternative embodiment capsule 16 is not subjected to any large tensile loads since capsule 16 may be inserted individually and separately by mechanical means into wellbore 25 (which may be lateral) and/or by mechanical means into cavern 27. In the embodiment wherein capsule 16 is used primarily as a transport or single delivery package, capsule 16 may be substantially constructed from material like polyvinyl chloride (PVC), plastics, similar materials, or the like. Many such plastic materials are inexpensive and DU kinetic elements 12 can be easily placed inside of plastic capsule 16. PVC has the necessary structural strength for this short duration process of transporting the DU waste down wellbore 25 to the repository. Then such a capsule 16 (with DU kinetic elements 12) may then then loaded (landed) singly in cavern 27 and/or in lateral wellbore 25 by mechanical means. In this embodiment, the ability to protect the ecosphere from radionuclide migration depends almost exclusively on deep geological rock formation 23 (host rock 23) and its intrinsic petrophysical and structural geological properties.

FIG. 2B may illustrate a perspective (isometric) view of the packaging of DU kinetic elements 12 in a capsule 16. In some embodiments, DU kinetic elements 12 may be “circle packed” inside capsule 16 and may be separated and held in place by supports 17. In some embodiments, the long-lived protective medium 18 may be placed inside capsule 16 which fills the void space and surrounds DU kinetic elements 12.

FIG. 2B shows a cylindrical form of capsule 16 and as a result its ability to be easily inserted and retrieved from a cylindrical wellbore 25 system using conventional oilfield service tools and apparatuses commonly found in routine oil and gas service operations. In some embodiments, capsule 16 may be substantially cylindrical in shape. In some embodiments, prior to packing, capsule 16 may be substantially hollow to accommodate receiving one or more DU kinetic elements 12 and supports/dividers 17.

FIG. 2C may illustrate a perspective isometric view of capsule 16 with substantially solid or cementitious waste DUM 28a stored within capsule 16. In some embodiments, solid or cementitious waste DUM 28a may be in a multiplicity of different forms. In some embodiments, solid or cementitious waste DUM 28a may be: a solid (like a salt); substantially a solid; a cementitious block; in aggregate may even be a powder, combinations thereof, and/or the like. In some embodiments, solid or cementitious waste DUM 28a may be shaped and/or packed to fit within a substantially cylindrical capsule 16. In the prior art, a considerable amount of research and effort has been made to convert DUM to other usable or less dangerous forms. All the solid material derived from such DUM conversion processes may be fashioned to allow emplacement and packaging inside a cylindrical capsule 16 as contemplated herein.

FIG. 2D may illustrate a longitudinal cross-sectional view of capsule 16 inside casing 20; wherein casing 20 may be inside of wellbore 25/26 in deep geological rock formation 23 (host rock 23). In some embodiments, a plurality of DU waste containing capsules 16 may be connected by a system of capsule couplings 24 which are attached (e.g., screwed and/or welded) unto the opposing terminal ends of a given capsule 16. In some embodiments, coupling 24 may be an oilfield standard industry product and is available in several different types depending on the depth of deep geological rock formation 23 (host rock 23) and the weight that must be carried by the capsule 16 string. In some embodiments, stored (housed) internal to capsule 16 may be solid or cementitious waste DUM 28a.

In some embodiments, capsules 16 with DU kinetic elements 12 (e.g., as shown in FIG. 2A) may also have coupling(s) 24 attached to the terminal ends of the given capsule 16.

In some embodiments of the configuration shown in FIG.2D, an annular space between capsule 16 (which may be in a string of capsules 16) and casing 20 may be filled with medium 19a (which may be a drill mud material as noted above) which may remain gelled over time but would still allow capsule(s) 16 to be retrieved back to surface 8 (see e.g., FIG. 4A for surface 8) by simple “pulling unit” systems, if needed after a specific period of disposal. This period of disposal may be up to 100 years in some applications. In other applications, more or less time may be applicable to the period of disposal. In some embodiments, in the case of non-retrieval disposal (i.e., intended permanent) storage, medium 19a may be a cement or cement like, such as cement 19b.

FIG. 3A may illustrate embodiments wherein a plurality of waste capsules 16 are connected to form a multi-capsule 16 string by using multiple couplings 24 to join sequential capsules 16 to form the given capsule 16 string. In some embodiments, the waste capsules 16 may be designed to be retrievable after they are inserted into the (lateral) wellbore(s) 25. In some embodiments, capsules 16 may be designed with end adapters or “nipples 24a” that are utilized at strategic intervals such that multiples of capsules 16 may be retrieved from the surface 8 (see e.g., FIG. 4A for surface 8) by available “fishing” tools in the oilfield industry. In some embodiments, these adapters or “nipples 24a” may be conventional devices which allow re-connection of given capsule 16 by downhole service tools and then capsule 16 retrievability to the surface 8 can be affected if needed and/or desired.

In some embodiments, the system may comprise at least one additional capsule 16 (that may be in addition to the at least one capsule 16), wherein this at least one additional capsule 16 may be configured for receiving at least some DU within the at least one additional capsule 16. That is, in some embodiments, the system may comprise at least two capsules 16, the at least one capsule 16 and the at least one additional capsule 16. See e.g., FIG. 3A.

In some embodiments, the system may further comprise at least one coupling 24; wherein the at least one coupling 24 may attach (removably so in some embodiments) the at least one capsule 16 to the at least one additional capsule 16 resulting in a string of capsules 16. In some embodiments, the system may comprise a string of capsules 16. In some embodiments, adjacent capsules 16 in the given string of capsules 16 may be attached to each other via coupling 24. In some embodiments, a string of capsules 16 may also be known as a plurality of capsules 16. In some embodiments, the string of capsules 16 may be arranged in a linear fashion end to end (as opposed to being arranged from side-wall to side-wall). See e.g., FIG. 2D and FIG. 3A.

In some embodiments, the system further may comprise at least one nipple 24a. In some embodiments, the at least one nipple 24a may be attached to an end of the at least one capsule 16 (e.g., an end closer to surface 8). In some embodiments, the at least one nipple 24a may be an attachment structure for facilitating inserting or retrieving of the at least one capsule 16 within the at least one wellbore 25/26. See e.g., FIG. 3A.

Continuing discussing FIG. 3A, in some embodiments, these capsule 16 strings may be deployed in the (lateral) wellbores 25/26 using techniques that are routinely done in the oilfield services to install down-hole tubular casings, tubing, equipment and/or devices.

Further illustrated in FIG. 3A, the well casing 20 is disposed inside of wellbore 25/26; and wellbore 25 lateral sections may be located in deep geological rock formation 23 (host rock 23). In some embodiments, in the annulus between wellbore 25 and casing 20 may be cement 19, which may be pumped and/or injected into such annuli. In some embodiments, several concentric casings 20 along with the requisite annuli may be implemented inside a given wellbore 25/26. In this embodiment, at least some portions of wellbore 25/26 is drilled in deep geological rock formation 23 (host rock 23).

FIG. 3B may illustrate an embodiment wherein solid or cementitious waste DUM 28a may be disposed of inside the (lateral) wellbore 25/26. In this embodiment, solid or cementitious waste DUM 28a may be placed into (lateral) wellbore 25/26 by pumping (e.g., as a slurry, pre-cured cement-like, or the like) or by other mechanical delivery means into the interior of casing 20 that is inside of (lateral) wellbore 25/26. FIG. 3B may also shows a schematic of plug 22 used at a proximal end of the (lateral) wellbore 25/26 section in which solid or cementitious waste DUM 28a may be disposed. In some embodiments, plug 22 may be of significant length. In some embodiments, plug 22 may seal wellbore 25/26. In some embodiments, plug 22 may seal casing 20. In some embodiments, plug 22 may seal wellbore 25/26 and/or casing 20.

FIG. 4A may illustrate a cross-section of an embodiment in which at least one DU waste disposal human-made cavern 27 is implemented in the given deep geological rock formation 23 (host rock 23). In this embodiment, human-made cavern 27 is intentionally created, formed, and drilled out from a given wellbore 25. This wellbore 25 which is initially drilled vertically from the earth's surface 8 may incorporate an S-shaped wellbore section 26 which may allow wellbore 25 to extend laterally; and then initiate a drilled vertical wellbore section after this lateral section; which is then under-reamed to form the given human-made cavern 27. In some embodiments, human-made cavern 27 is made by under-reaming at least some portion(s) of the vertical and/or the lateral wellbore 25. Further illustrated in FIG. 4A is waste DUM 28 which may be placed in the well of human-made cavern 27 from surface 8. In some embodiments, the volume of human-made cavern 27 may be at least partially filled with waste DUM 28. In some embodiments, the volume of human-made cavern 27 may collect waste DUM 28.

In some embodiments, deep geological rock formation 23 (host rock 23) may be one or more of: impermeable sedimentary rock, very low permeability sedimentary rock, impermeable metamorphic rock, very low permeability metamorphic rock, impermeable igneous rock, very low permeability ingenious rock, combinations thereof, and/or the like. “Impermeable” in this context may be with respect to water migration and/or with respect to radionucleotide migration. “Impermeable” may be having permeability measurements less than 10 nanodarcy. “Very low permeability” in this context may be with respect to water migration and/or with respect to radionucleotide migration. “Very low permeability” may be having permeability measurements between 10 and 1,000 nanodarcy.

In some embodiments, deep geological rock formation 23 (host rock 23) may be subterranean (underground), located at least 10,000 feet to 30,000 feet below an Earth surface 8 location, plus or minus 1,000 feet.

Continuing discussing FIG. 4A, upon surface 8 may be remote surface location 6, wellsite support buildings/structures 7, and drilling rig 9. Remote surface location 6 may be located offsite from drilling rig 9. Remote surface location(s) 6 may house DU kinetic elements 12 in need of long-term disposal/storage. Remote surface location(s) 6 may house clean steel storage cylinders 14 with DUF and/or rusted and/or degraded steel storage cylinders 15 with DUF. In some embodiments, drilling rig 9 may be used to drill wellbores 25. In some embodiments, drilling rig 9 may be substantially as drilling rigs used in oilfield operations. In some embodiments, wellsite support buildings/structures 7 may be onsite and/or proximate with respect to drilling rig 9. In some embodiments, wellsite support buildings/structures 7 may have temporary (short-term) storage of various DUP, DUM, and/or DUF.

In some embodiments, at least one wellbore 25/26 may extend into the deep geological rock formation 23 (host rock 23); wherein the at least one wellbore 25/26 may be configured to receive the at least one capsule 16 (e.g., with some DU).

In some embodiments, the at least one wellbore 25/26 may be formed from drilling rig 9. See e.g., FIG. 4A.

In some embodiments, the at least one wellbore 25/26 may be drilled from an Earth surface 8 location. See e.g., FIG. 4A.

In some embodiments, the at least one wellbore 25/26 may be comprised of at least one substantially vertical section (generally denoted with reference numeral “25”), at least one substantially horizontal section (lateral section) (generally denoted with reference numeral “26”), and at least one transitional section (generally denoted with reference numeral “26”) that may links the at least one substantially vertical section 25 to the at least one substantially horizontal section 26; wherein “vertical” and “horizontal” may be with respect to an Earth surface 8 location located above the at least one wellbore 25/26, wherein the Earth surface 8 location may be deemed a substantially horizontal surface.

In some embodiments, a distal end of the at least one wellbore 25/26 may terminate at an end of the at least one substantially horizontal section 26.

In some embodiments, a distal end of the at least one wellbore 25/26 may terminate at an entrance to at least one human-made cavern 27, wherein the at least one human-made-cavern 27 may be located within the deep geological rock formation 23 (host rock 23).

In some embodiments, the at least one wellbore 25/26 may have at least one diameter that is drilled at a particular and predetermined size. In some embodiments, wellbore 25/26 may have different diameters, but each different diameter may be of a fixed sized. In some embodiments, a diameter of wellbore 25/26 may be from ten to 48 inches, plus or minus 6 inches.

In some embodiments, the at least one wellbore 25/26 may have a length from 5,000 feet to 30,000 feet, plus or minus 1,000 feet.

In some embodiments, a distal end of away from an Earth surface 8 location of the at least one wellbore 25/26 may be a final depository location for DU.

In some embodiments, the at least one wellbore 25/26 may be a transit means configured for transit of DU through the at least one wellbore 25/26.

In some embodiments, the at least one human-made cavern 27 may be substantially cylindrical in shape. In some embodiments, a length of human-made cavern 27 may be substantially parallel with the substantially vertical section of wellbore 25. See e.g., FIG. 4A, FIG. 4B, and FIG. 4C. In some embodiments, a length of human-made cavern 27 may be substantially parallel with the substantially horizontal (lateral) section of wellbore 26 (this embodiment is not shown in the drawings).

In some embodiments, the at least one human-made cavern 27 may have a volume that may be fixed and predetermined, wherein this volume may be selected from the range of 100,000 gallons to 2,000,000 gallons for a given at least one human-made cavern 27, plus or minus 10,000 gallons.

In some embodiments, the at least one human-made cavern 27 may be a final depository location for storage of at least some DU.

In some embodiments, the at least one capsule 16 (with at least some DU in some embodiments) may be received into the at least one human-made cavern 27.

FIG. 4B may illustrate a cross-section of an embodiment in which a DU waste disposal human-made cavern 27 may be implemented in the given deep geological rock formation 23 (host rock 23). Illustrated in FIG. 4B is an embodiment in which a pumpable or flowable waste DUM 28 with a slurry-like consistency is placed (e.g., by pumping) into the well of human-made cavern 27 from surface 8.

FIG. 4C may illustrate an embodiment in which waste DUM 28 capsules are disposed in human-made cavern(s) 27 which may be implemented in the given deep geological rock formation 23 (host rock 23). Illustrated in FIG. 4C is an embodiment in which the waste DUM 28 capsule is placed into the well of human-made cavern 27 from surface 8. In addition, a supernatant liquid 28b may remain in human-made cavern 27 surrounding (covering) the capsules of waste DUM 28. In some embodiments, this supernatant liquid 28b may provide additional protective properties by minimizing radionuclide migration away from the waste DUM 28 capsules.

In some embodiments, supernatant medium 28b may be at least one filler, wherein this at least one filler may fill in void space around DU that is inside of the at least one human-made cavern 27. See e.g., FIG. 4C. In some embodiments, this at least one filler may provide one or more of the following functions within the at least one human-made cavern 27: immobilizes solids, absorbs radionuclides, absorbs radiation, resists corrosion, resists oxidation, scavenges oxygen, scavenges free radicals, combinations thereof, and/or the like.

FIG. 4D may illustrate an embodiment in which a plurality of human-made caverns 27 (configured for receiving waste DUM) may be implemented in a linear or geometrical pattern from a given vertical wellbore 25, in the given deep geological rock formation 23 (host rock 23). In addition, in some embodiments applicable to FIG. 4D, different physical forms of the waste DUM, such as, but not limited to, capsules, immobilized material, and/or pumpable fluids may be sequestered in different human-made caverns 27. In some embodiments, plurality of human-made caverns 27 may be located within the deep geological rock formations 23 (host rocks 23), wherein the at least one wellbore 25/26 may branch out to connect to each human-made cavern 27 selected from the plurality of human-made caverns 27. See e.g., FIG. 4D.

In some embodiments, human-made cavern 27 may be configured to receive DU in various forms and/or formats, such as, in capsules 16/28, DUP, DUM, DUF, solids, liquids, slurries, combinations thereof, and/or the like. In some embodiments, DU (in various forms and/or formats, such as, DUP, DUM, DUF, solids, liquids, slurries, combinations thereof, and/or the like) may be stored (and/or disposed of) in a given human-made cavern 27 without use of capsules 16/28.

In some embodiments, the at least one wellbore 25/26 may terminate in the at least one human-made cavern 27. See e.g., FIG. 4A, FIG. 4B, FIG. 4C, and FIG. 4D. In some embodiments, wellbore 25/26 may be a plurality of wellbores 25/26 that may each terminate in its own human-made cavern 27, see e.g., FIG. 4D.

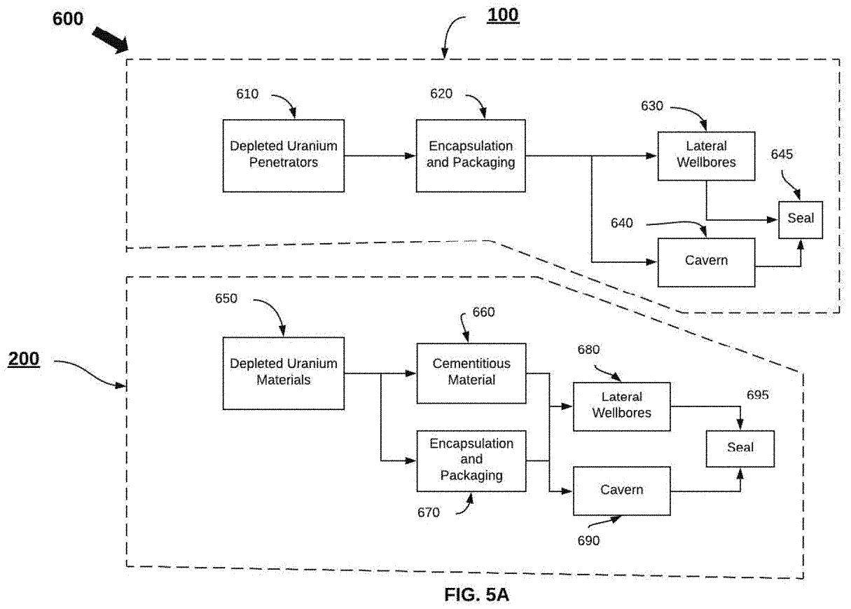

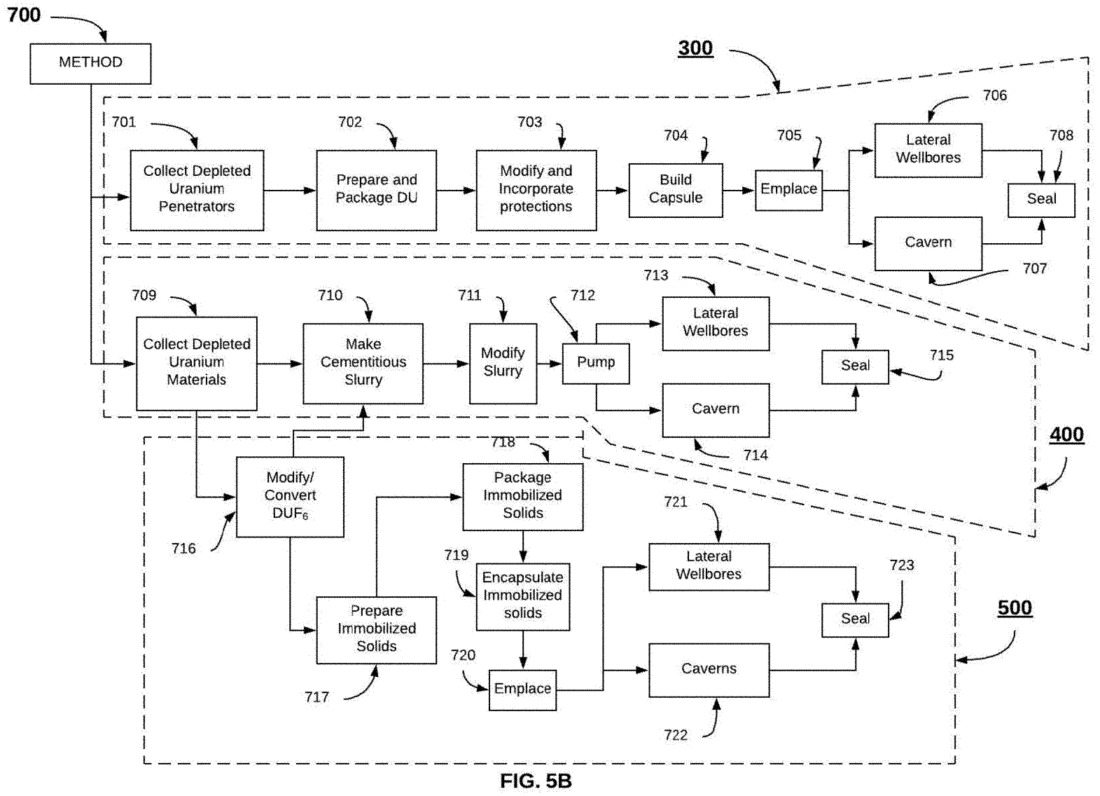

FIG. 5A may illustrate a decision flow chart as an overview, identifying by sequential decisions, some systems, some methods, and some operations utilized by various embodiments of this invention.

FIG. 5A may depict a flowchart summarizing method 600. In some embodiments, method 600 may be a method showing operations involved in long-term disposing (or storing) of various DU products, DUP, DUM, and/or DUF in one or more repositories: (a) in deep lateral wellbore(s) 25; (b) in casing(s) 20 that are in deep lateral wellbores 25; (c) in capsule(s) 16 that are in deep lateral wellbore(s) 25; (d) in capsule(s) 16 that are in casing(s) 20 that are in turn in deep lateral wellbore(s) 25; (e) in deep human-made caverns 27 reachable from one or more wellbore(s) 25; (f) in capsule(s) 16 that are in deep human-made caverns 27 reachable for one or more wellbore(s) 25; combinations thereof; and wherein each of these repositories (intended final disposal/storage locations) may be located in deep geological rock formation 23 (host rock 23).

In some embodiments, the materials to be disposed of (stored) may be one or more of: DU kinetic element 12, waste DUM 28, solid or cementitious waste DUM 28a, and/or waste DUM 28a that was injected/pumped in as a slurry (or slurry like). In some embodiments, method 600 may comprise two sub-methods 100 and 200.

In some embodiments, sub-method 100 operations may be a method of DUP disposal/storage specifically applied to DU (penetrator) kinetic elements 12. In some embodiments, sub-method 100 may comprise steps 610 to 645. In some embodiments, in sub-method 100, in step 610 the DU (penetrator) kinetic elements 12 may be collected; and in step 620 the DU kinetic elements 12 may be encapsulated, forming capsule(s) 16 with DU kinetic elements 12. In step 630 the capsules 16 may be sequestered in lateral wellbores 25. In step 640 the capsules 16 may be loaded into human-made cavern(s) 27. In step 645 the lateral wellbores 25 and human-made cavern(s) 27 may be sealed.

Continuing discussing FIG. 5A, in some embodiments, sub-method 200 operations may be a method of DUM disposal/storage. In some embodiments, sub-method 200 may comprise steps 650 to 695. In some embodiments, sub-method 200 may relate generally or specifically to the disposal/storage of DUM as cementitious mixtures like slurries, slurry like, and/or as encapsulated or as packaged material not including depleted penetrators 12.

Continuing with FIG. 5A, in some embodiments, sub-method 200 deals with DUM disposal and storage. In some embodiments, in sub method 200, in step 650 the waste DUM 28 may be collected; in step 660 the waste DUM 28 may be modified into cementitious form and/or slurries. Further, in sub-method 200, as an alternative, in step 670, the waste DUM 28 may be encapsulated and packaged. At step 680, the waste DUM 28 may be sequestered in lateral wellbores 25. In addition, in step 690, the waste DUM 28 may be sequestered in human-made cavern(s) 27. In step 695, the lateral wellbores 25 and human-made cavern(s) 27 may be sealed.

Some of the steps of method 600, sub-method 100, and/or sub-method 200 may be mandatory, while other steps may be optional. In some cases, some steps may be done out of order of the sequence noted in FIG. 5A.

FIG. 5B may depict a flowchart of method 700. In some embodiments, method 700 may be a method of (long-term) disposing (or storing) of various DU products, DUP, DUM, and/or DUF in one or more repositories: (a) in deep lateral wellbore(s) 25; (b) in casing(s) 20 that are in deep lateral wellbores 25; (c) in capsule(s) 16 that are in deep lateral wellbore(s) 25; (d) in capsule(s) 16 that are in casing(s) 20 that are in turn in deep lateral wellbore(s) 25; (e) in deep human-made caverns 27 reachable from one or more wellbore(s) 25; (f) in capsule(s) 16 that are in deep human-made caverns 27 reachable for one or more wellbore(s) 25; combinations thereof—wherein each of these repositories (intended final disposal/storage locations) may be located in deep geological rock formation 23 (host rock 23). In some embodiments, the to be disposed of (stored) may be one or more of: DU kinetic element 12, waste DUM 28, solid or cementitious waste DUM 28a, and/or waste DUM 28a that was injected/pumped in as a slurry (or slurry like). In some embodiments, method 700 may comprise sub-tasks 300, 400, and/or 500.

In some embodiments, sub-task 300 may be a method of DUP disposal/storage. In some embodiments, sub-task 300 (method 300) may comprise steps 701 to 708. In some embodiments, sub task 300 (method 300) may relate generally to the disposal/storage of DUP(s).

In some embodiments, sub-task 400 may be a method of DUM disposal/storage. In some embodiments, sub-task 400 (method 400) may comprise steps 709 to 715. In some embodiments, sub task 400 (method 400) may relate generally to the disposal/storage of DUM as cementitious mixtures like slurries, slurry like, and/or similar flowable mixtures or materials.

In some embodiments, sub-task 500 may be a method of DUM immobilization. In some embodiments, sub-task 500 (method 500) may comprise steps 716 to 723. In some embodiments, sub task 500 (method 500) may relate generally to the disposal/storage of DUM as solids and/or immobilized materials.

Some of the steps may be mandatory, while other steps may be optional. In some cases, some steps may be done out of order of the sequence noted in FIG. 5B.

Continuing discussing FIG. 5B, in some embodiments, step 701 of subtask 300 (method 300), may be a step of locating and collecting DUPs, such as DU armor piercing rounds (munitions) 3. In some embodiments, in step 701, these DUPs may be located at and retrieved from various surface 8 or near surface 8 storage locations, such as remote surface storage locations of DU waste 6. These remote surface storage locations of DU waste 6 may be various storage warehouses, military stations, and/or the like—sometimes from surplus operations. In some embodiments, in step 701, such located and retrieved (collected) DUPs may be consolidated and/or temporarily (short-term) stored at wellsite support buildings/structure 7. In some embodiments, in step 701, the collected DU armor piercing rounds (munitions) 3 may be processed into the DU kinetic elements 12 for the long-term disposal/storage. That is, in some embodiments in step 701 the collected DU armor piercing rounds (munitions) 3 may be stripped to remove the non-nuclear elements (such as propellant 4, primer 5, sabot body 10, fin stabilizers 11, and/or tracer elements 13) leaving DU kinetic elements 12 as the DUP elements in need of long-term disposal/storage. In some embodiments, successful completion of step 701 may then progress into step 702.

Continuing discussing FIG. 5B, in some embodiments, step 702 may be a step of preparing and packaging of DU kinetic elements 12 for long-term disposal/storage. In some embodiments, DU kinetic elements 12 may be “circle-packed” inside a given capsule 16 to maximize the weight per volume ratio of the given capsule 16 and thus allowing maximum disposal quantities at lowest overall cost. Supports/dividers 17 may be implemented internal to the given capsule 16 between DU kinetic elements 12 to provide stability, durability, and/or strength to the given capsule 16. In some embodiments, successful completion of step 702 may then progress into step 703.

Continuing discussing FIG. 5B, in some embodiments, step 703 may be a step of modifying, protecting, and/or pre-encapsulation processes involved in making sure that the DU kinetic elements 12 as disposed in the deep wellbore(s) 25 and/or in human-made cavern(s) 27 are protected for a very long times from degradation, such as, not limited to, up to 10,000 years, plus or minus 100 years. In other embodiments, other long term storage times may be applicable. In some embodiments, in step 703 protective medium 18 may be inserted into the void spaces surrounding DU kinetic elements 12, their supports/dividers 17, and within the internal walls of the given capsule 16. Regarding protective medium 18, see the above discussion of FIG. 2A. In some embodiments, step 703 may be optional. When step 703 may be omitted, step 702 may progress to step 704. In some embodiments, successful completion of step 703 may then progress into step 704.

In this step 703, it may be contemplated that the packaging of DU kinetic elements 12 may be somewhat similar to a typical “canning” operation in an industrial setting with the inclusion of the required safety considerations for the radioactive nature of the DUP waste. Nothing in the physical packaging process may be considered as being challenging in the industry today (2019).

Continuing discussing FIG. 5B, in some embodiments, step 704 may be a step of building (creating and/or forming) a string of capsules 16, wherein at least one such capsules 16 may contain DU kinetic elements 12 (and may also contain protective medium 18). In some embodiments, in this step 704 capsule(s) 16 are made into device(s) that are structurally capable of being utilized in the typical operations of a modern-day oil well drilling or well servicing operational environment. In some embodiments, in step 704, coupling(s) 24 may be added to and attached to capsule 16 terminal ends as shown in FIG. 2D and/or in FIG. 3A. In such a manner a string of capsules 16 may be formed. In some embodiments, the intended proximate end (the end that will be closest to surface 8 via its wellbore 25) of this string of capsules 16 have attached nipple 24a. In some embodiments, a given string of capsules 16 (with DU kinetic elements 12) may substantially conform to the practices and ways of the “oil patch” since the oil and gas industry has an overwhelming amount of expertise, experience, and operational technologies which can help make the nuclear industry and especially its waste disposal operations in deep geological repositories (deep geological rock formation 23 (host rock 23)) a success. By conforming to the accepted oil-field practices, this invention may fit seamlessly into operational strategies and protocols worldwide. In some embodiments, in step 704 string of capsules 16 may be made “oil-field” ready. In some embodiments, in step 704 couplings 24 and/or connection nipples 24a may be added to capsules 16 as needed and/or desired. In some embodiments, in step 704 centralizers 21 may be installed on the capsule 16 exteriors as needed and/or desired. In some embodiments, in step 704 several capsules 16 may be connected together by couplings 24 to form a capsule 16 string as shown in FIG. 3A. This “stringing” operation is typical in the oil well service industry in which multiple pieces of tubular goods, casings, tubing, and/or sucker rods are connected together to form a longer string of elements and these stringed elements are then inserted into the given wellbore as an integral unit. This stringing together process is more efficient and more rapid than inserting one capsule 16 or tubular element at a time. In some embodiments, successful completion of step 704 may then progress into step 705.

In some embodiments, step 704 may include the building of a “cheaper version” of a capsule 16 in which capsule 16 may be used for transporting the DU into the final emplacement position in the deep underground system. In this embodiment, this inexpensive type capsule 16 may normally be used only for sequestering DU waste in deep human-made caverns 27 where capsules 16 may be landed individually or in small batches from surface 8 by mechanical means and the cavern 27 walls and deep geological rock formation 23 (host rock 23) become the protective system for long term viability of the DU waste. In these embodiments, capsule 16 may be made of materials like PVC or similar inexpensive yet structurally competent materials. In some embodiments, successful completion of step 704 may then progress into step 705.

Continuing discussing FIG. 5B, in some embodiments, step 705 may be a step of emplacing (deploying/placing/locating/landing/depositing) capsule(s) 16 (with DU kinetic elements 12) in either a lateral wellbore 25 or in a human-made cavern 27. Thus, step 705 may be further divided into step 706 for emplacing in lateral wellbores 25 or step 707 for emplacing in human-made cavern(s) 27.

Continuing discussion of FIG. 5B, in some embodiments, step 706 may be a step of landing capsule(s) 16 (with DU kinetic elements 12) in lateral wellbores 25. This may be accomplished by either inserting capsules 16 (with DU kinetic elements 12) singly or in groups (strings) from surface 8 with typical drilling rig systems and/or coiled tubing systems. This type operation in step 706 may provide a downhole system that is shown in FIG. 3A where several capsules 16 are shown in a wellbore 25. These operations are routine to oilfield operations and may usually be time consuming. In some embodiments, successful completion of step 706 may then progress into step 708.

Continuing discussion of FIG. 5B, in some embodiments, step 707 may be a step of landing capsule(s) 16 (with DU kinetic elements 12) in human-made cavern(s) 27. This may be accomplished by either inserting capsule(s) 16 (with DU kinetic elements 12) singly or in groups (strings) from surface 8 with typical drilling rig systems and/or coiled tubing systems. In some operations capsule(s) 16 (with DU kinetic elements 12) may be landed by other available mechanical means thereby allowing the capsules 16 (with DU kinetic elements 12) to “pile up” in the cavern 27 as shown in FIG. 4A. In some embodiments, successful completion of step 707 may then progress into step 708.

Continuing discussion of FIG. 5B, in some embodiments, step 708 may be a step of sealing of the DU waste material inside the lateral wellbores 25 and/or sealing of the DU waste material inside in the human-made caverns 27. In one embodiment, the lateral wellbore 25 (with capsules 16) may be sealed by materials that would provide closure and mitigate migration of radionuclides away from the repository zone. These sealing materials may comprise: cement slurries, specially prepared bentonite or vermiculite clays, and/or oilfield packer systems which may be retrievable or non-retrievable. In other embodiments, the free void spaces between the elements of the waste DUM 28 stored in the human-made caverns 27 may be filled by material pumped from the surface 8. This material in addition to filling the void (pore) spaces, may also provide a supernatant cap above and around the stored waste DUM 28. In this embodiment, the supernatant medium 28b may protect waste DUM 28 and may also provide a migratory block to radionuclides. In some embodiments, the following sealing materials may be utilized: special bentonite muds which have been treated to form a long-lived stable gel; special vermiculite clay suspensions; heavy crude with API gravity less than 10 deg.; cement slurries; and/or combinations thereof of fluids that are designed for longevity in deep geological rock formations. It is noted in the prior art that heavy oil deposits have been discovered in oil exploration and in the geological record, have remained inert and immobile for millions of years.

Continuing discussing FIG. 5B, in some embodiments, step 709 of subtask 400 (method 400), may be a step of collecting DUM. The DUM may be of different types. The DUM may be derived from DUF. The DUF may be converted into solids, such as metals and/or oxides of uranium and/or derivatives. In some embodiments, successful completion of step 709 may then progress into step 710. (In some embodiments, successful completion of step 709 may then progress into step 716.)

Continuing the discussion of FIG. 5B, in some embodiments in step 710, the solid DUM are physically and mechanically converted into cementitious mixtures and/or slurries. Step 716 of FIG. 5B may be implemented before step 710. The DUM is converted as explained herein later, to a plurality of different disposable forms. In this step 710, a grout may be made with the waste DUM. Step 710 prepares the waste DUM for additional physical changes needed to make the waste DUM transportable into the wellbore 25 and/or into the deep human-made caverns 27. In some embodiments, successful completion of step 710 may then progress into step 711.

Continuing discussing FIG. 5B, in some embodiments, step 711 may be a step of modifying the cementitious DUM mixtures/slurries. In this step 711, the slurry mixtures may be modified by adding various additives (i.e., specific chemicals) to stabilize the slurry and/or change/adjust the rheological, chemical, and physical properties of the mixture/slurry and/or to enhance behavior of the slurry. These additives are well developed in the oil and gas industry for a variety of operating temperatures, pressures, and rock formation properties. These additives may comprise: friction reducers, accelerators, retarders, extenders, weighting agents, fluid loss additives, scale inhibitors, lost circulation additives, expansion additives, dispersants, antifoam agents, combinations thereof, and/or the like. In some embodiments, successful completion of step 711 may then progress into step 712. In some embodiments, step 711 may be optional; and when step 711 may be omitted, then step 710 may progress into step 712.

Continuing discussing FIG. 5B, in some embodiments, step 712 may be a step of pumping the cementitious DUM mixture/slurry into the lateral wellbore 25 and/or into the deep human-made cavern 27. In this step 712, the wellhead pumping equipment may comprise the parts, components, devices, apparatus, machines, and/or systems commonly used in the oil and gas and/or cementing industry, where millions of gallons of cement are regularly pumped into deep wellbores to cement the well casings in place and to provide an impermeable barrier to fluid migration away from the wellbore into downhole or up-hole formations. In some embodiments, step 712 may be a step of pumping the waste DUM slurries in either a lateral wellbore 25 or into a human-made cavern 27. Thus, step 712 may be further divided into step 713 for pumping into lateral wellbores 25 or step 714 for pumping into human-made cavern(s) 27.

Continuing discussing FIG. 5B, in some embodiments, step 713 may be a step of pumping the cementitious/slurry DUM into the lateral wellbore 25. In step 713 the cementitious slurry DUM may at least partially fill the internal space inside of casing(s) 20 of the lateral wellbore 25. In some embodiments, successful completion of step 713 may then progress into step 715.

Continuing discussing FIG. 5B, in some embodiments, step 714 may be a step of pumping the cementitious/slurry DUM mixture into the deep human-made cavern(s) 27. In this, step 714 the waste DUM may at least partially fill and “pool” up in the internal space in the given human-made cavern 27. In some embodiments, successful completion of step 714 may then progress into step 715.

Continuing discussing FIG. 5B, in some embodiments, step 715 may be a step of sealing the cementitious/slurry DUM mixture in the lateral wellbore(s) 25 and/or sealing the cementitious/slurry DUM mixture in the deep geological human-made cavern(s) 27. In this step 715, a seal may be placed above (upstream) of the cementitious/slurry DUM disposed in the wellbore 25. This seal may be comprised of: bentonite clays, cements, a physical packer or cast-iron plugs or similar plugging devices currently in use in the oil industry, combinations thereof, and/or the like. In some embodiments, in step 715 the sealing process for a given human-made cavern 27, a sealing mixture may be injected into the given human-made cavern 27 above the cementitious/slurry DUM in that given human-made cavern 27. The sealing material may be selected from: bentonite clays, cements, other protective compounds, combinations thereof, and/or the like. In some embodiments, the sealing material may harden and/or cure over time.

Continuing discussing FIG. 5B, in some embodiments, step 716 of subtask 500 (method 500), may be a step of modifying and/or converting DUF into solid DUM. The resulting modified or converted DUM may be of different types of solids with varying desirable disposal/storage qualities/properties. The resulting modified or converted DUM may be derived from DUF. The resulting modified or converted DUM (from DUF) may be of the following forms:
(a) metal (e.g., billet or ingot), these are the densest forms and require the least volume per unit weight, they also pose no major containment problems;
(b) UO₂ sintered shapes, these are very dense forms of the stable oxide which poses no containment problems;
(c) UO₂ aggregate forms, these are dense stable oxide forms which pose no containment problems;
(d) U₃O₈ powder, this is a very stable waste form and containment precautions must be taken in packaging these powders;
(e) UF₄ powder, this is a relatively stable form which must be protected from corrosion during storage and disposal and containment;
(f) UO₃ powder, this is a fairly dense oxide form which is hygroscopic and must be protected from moisture and aqueous environments;
(g) UO₂ powder, this is a dangerous product which converts to U308 in air with a volume change and tends to be pyrophoric under certain circumstances; (h) combinations thereof; and/or the like.

Regardless of the form of the DUF products, the safest form for disposal needs to be determined and implemented. The DUF must be safely disposed of away from the ecosphere. The DUF conversion process occurs at sites remote from the well sites where waste disposal occurs. DUF conversion is a massive industrial undertaking at this time (2019).

In some embodiments, successful completion of step 716 may then progress into step 717. (In some embodiments, successful completion of step 716 may then progress into step 710.)

Continuing the discussion of FIG. 5B, in some embodiments step 717 may be a step of immobilizing DUF products. In some embodiments, step 717 immobilization of DUF may be via one or more of: cementation, bituminization, vitrification, ceramification, combinations thereof, and/or the like. These immobilization processes may occur at sites remote from the well sites where waste DUF disposal occurs. DUF product immobilization is a massive industrial undertaking at this time (2019). In the prior art, immobilization is usually the endpoint of the waste process and the immobilized solids are then warehoused in shallow burial, surface storage or other near surface waste systems. In some embodiments, successful completion of step 717 may then progress into step 718.

Continuing the discussion of FIG. 5B, in some embodiments step 718 may be a step of packaging the immobilized DUF products for incorporation into a capsule 16 system and/or for introduction into the wellbore 25 and/or for introduction into a given human-made cavern 27. In some embodiments, in step 718 the immobilized DUF product may be formed into cylindrical blocks that may be inserted into a given cylindrical capsule 16. In some embodiments, in step 718 the immobilized DUF products may be converted into aggregate-like products of varying sizes. These aggregates can be the size of gravel or small pebbles of less than 2-inch diameter plus or minus half an inch. In some embodiments, successful completion of step 718 may then progress into step 719.

Continuing the discussion of FIG. 5B, in some embodiments step 719 may be a step of encapsulating the immobilized DUF into a given capsule 16. In one embodiment, the solid cylindrical immobilized blocks of DUF may be placed in the given capsule 16. The solid immobilized DUF blocks may be inserted in the capsule 16 and the capsule 16 may then closed. In another embodiment, the aggregate DUF material may be inserted or poured into the given capsule 16.; and then that given capsule 16 may be closed. In some embodiments, successful completion of step 719 may then progress into step 720.

Continuing discussing FIG. 5B, in some embodiments, step 720 may be a step of emplacing (deploying/placing/locating/landing/depositing) the capsules 16 (with immobilized DUF) in a lateral wellbore system 25 and/or in a deep human-made cavern 27. Thus, step 720 may be further divided into step 721 for emplacing into lateral wellbores 25 or step 722 for emplacing into human-made cavern(s) 27.

Continuing discussing FIG. 5B, in some embodiments, step 721 may be a step of emplacing (deploying/placing/locating/landing/depositing) capsule(s) 16 (with immobilized DUF) into lateral wellbore(s) 25. In some embodiments, step 721 may involve landing the capsules 16 (with immobilized DUF) in lateral wellbores 25. This may be accomplished by either inserting the capsules 16 (with immobilized DUF) singly or in groups (strings) from surface 8 with typical drilling rig systems or coiled tubing systems. This type operation in step 721 may provide a downhole system that is shown in FIG. 3A where several capsules 16 are shown in a wellbore 25. These operations are routine and may usually be time consuming. In some embodiments, successful completion of step 721 may then progress into step 723.

Continuing discussion of FIG. 5B, step 722 may be a step of emplacing (deploying/placing/locating/landing/depositing) capsule(s) 16 (with immobilized DUF) into human-made cavern(s) 27. This may be accomplished by either inserting the capsule(s) 16 (with immobilized DUF) singly or in groups (strings) from surface 8 with typical drilling rig systems or coiled tubing systems. In some operations the capsules 16 (with immobilized DUF) may be landed by other available mechanical means thereby allowing the capsules to pile up in the given human-made cavern 27; e.g., as shown in FIG. 4A. In some embodiments, successful completion of step 722 may then progress into step 723.

Continuing discussion of FIG. 5B, step 723 may be a step of sealing of the waste DUM inside the lateral wellbores 25 and/or sealing of the waste DUM inside the human-made caverns 27. In one embodiment, the lateral wellbore 25 may be sealed by materials that would provide closure and mitigate migration of radionuclides. These sealing materials may comprise: cement slurries, specially prepared bentonite or vermiculite clays, oilfield packer systems which may be retrievable or non-retrievable. In other embodiments, the free void spaces between the elements of immobilized DUF stored in the caverns 27 may be at least partially filled by sealing material pumped from the surface 8. This sealing material in addition to filling the free void (pore) spaces may also provide a supernatant cap above and around the stored immobilized DUF. In this embodiment, the supernatant medium 28b may protect the waste immobilized DUF and may also provide a migratory block to radionuclides. In some embodiments the following sealing materials may be utilized: special bentonite muds which have been treated to form a long-lived stable gel; special vermiculite clay suspensions; heavy crude with API gravity less than 10 deg.; cement slurries; combinations thereof of fluids that are designed for longevity in deep formations; and/or the like.

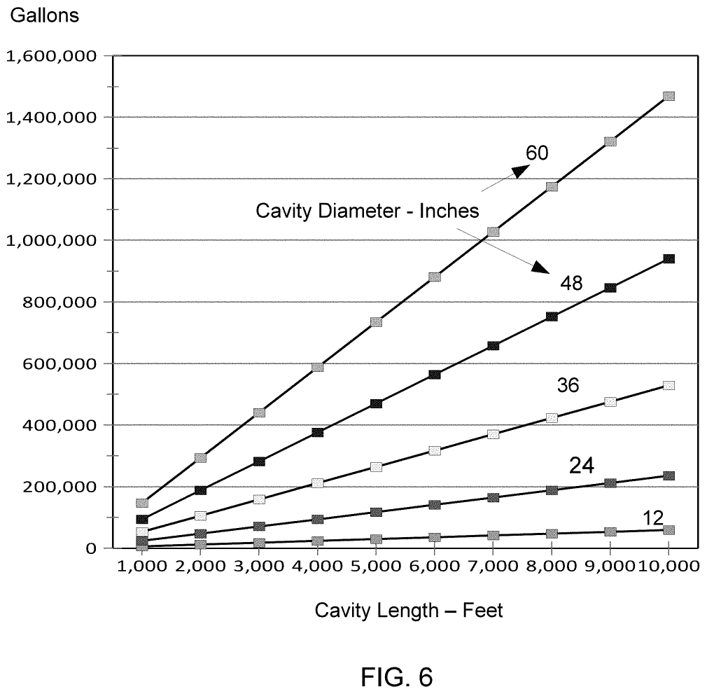

FIG. 6 may show a graph of the volumetric capacity in gallons for human-made cavities 27 varying in length from 1,000 feet to 10,000 feet and diameters from 12 inches to 60 inches.

In some embodiments, the system described herein may be a system for storing (and/or for long-term disposal of) depleted uranium (DU) in a deep geological rock formation 23 (host rock 23). In some embodiments, such a system may comprise at least one capsule 16. In some embodiments, the system may further comprise at least one wellbore 25/26.

In some embodiments, the system may further comprise at least one divider 17, wherein the divider 17 may be insertable into the at least one capsule 16. In some embodiments, the system may further comprise casing 20, wherein casing 20 may be inserted into the at least one wellbore 25/26 and around the at least one capsule 16. See e.g., FIG. 2A.

In some embodiments, the system may further comprise protective medium 18. In some embodiments, protective medium 18 may substantially fill in void space around the DU that is within the at least one capsule 16. In some embodiments, protective medium 18 may be configured for minimizing degradation of the at least one capsule 16 from radiation emitted by the DU.

In some embodiments, the system may further comprise a gas blanket. In some embodiments, the gas blanket may substantially fill in void space around the DU that is within the at least one capsule 16 to minimize a presence of oxygen in the at least one capsule 16. In some embodiments, the blanket gas may purge (push out) oxidizing gasses, such as oxygen present in air within the at least one capsule 16. In some embodiments, a gas for use in the gas blanket may be an inert gas or a substantially inert gas. In some embodiments, a gas for use in the gas blanket may be nitrogen gas.

In some embodiments, the system may further comprise a centralizer 21. In some embodiments, the systems and/or methods described herein, may comprise at least three centralizes 21, substantially equal distant spaced around capsule 16. In some embodiments, the systems and/or methods described herein, may comprise four centralizes 21, substantially equal distant spaced around capsule 16, see e.g., FIG. 2A.

In some embodiments, the system may comprise drilling rig 9, see e.g., FIG. 4A. In some embodiments, the at least one wellbore 25/26 may be formed from drilling rig 9. See e.g., FIG. 4A.

In some embodiments, the system may further comprise a filler (such as, but not limited to, medium 19a), wherein this filler may substantially fill in space between an interior of casing 20 and an exterior of the at least one capsule 16.

In some embodiments, the system may further comprise a filler (such as, but not limited, cement 19b), wherein this filler may substantially fills in space between an exterior of casing 20 and an interior of the at least one wellbore 25/26.

In some embodiments, the system may further comprise at least one human-made cavern 27 configured for receiving at least some DU for storage, wherein the at least one human-made cavern 27 may be located within the deep geological rock formation 23 (host rock 23). See e.g., FIG. 4A, FIG. 4B, FIG. 4C, and FIG. 4D.

In some embodiments, the system may further comprise at least one filler (such as, but limited to, supernatant medium 28b), wherein the at least one filler may fill in void space around DU that is inside of the at least one human-made cavern 27. See e.g., FIG. 4C.

In some embodiments, the system may further comprise a plurality of human-made caverns 27, each configured for receiving at least some DU, wherein this plurality of human-made caverns 27 may be located within the deep geological rock formations 23 (host rocks 23), wherein the at least one wellbore 25/26 may branch out to connect to each human-made cavern 27 selected from the plurality of human-made caverns 27. See e.g., FIG. 4D.

In some embodiments, the storage time-frame contemplated for the systems and methods described herein may be intended for up to 10,000 years, plus or minus 100 years. In some embodiments, the storage time-frame contemplated for the systems and methods described herein may be configured for up to 10,000 years, plus or minus 100 years.

In some embodiments, the types of DU that the systems and/or methods described herein may be configured for storing, may comprise at least a portion of DU in a form as one or more of: at least a portion of a projectile; or at least a portion of a munition—such as, but not limited to, DU kinetic element 12 (DU penetrator 12).

In some embodiments, the types of DU that the systems and/or method described herein may be configured for storing, may comprise at least a portion of DU in a form as one or more of: at least a portion of a solid; at least a portion of a salt; at least a portion of a liquid; at least a portion of a slurry; at least a portion of an aggregate; at least a portion of a cement; at least a portion of a ceramic; at least a portion of a glass; at least a portion of a block; at least a portion of a powder; at least a portion of a pellet, combinations thereof, and/or the like. In some embodiments, the DU to be stored may be substantially pumpable and/or substantially flowable to facilitate transit through wellbore(s) 25/26.

In some embodiments, the system may comprise the DU to be stored or that is stored according to an embodiment of this present invention. In some embodiments, the DU to be stored may be substantially pumpable and/or substantially flowable to facilitate transit through wellbore(s) 25/26.

Means, systems, mechanisms, and methods for the long-term disposal and/or storage and/or of depleted uranium (DU) penetrators and DU materials as waste (e.g., nuclear waste) within deep lateral wellbores and/or within human-made subterranean cavities (caverns) within deep geological rock formations have been described. The foregoing description of the various embodiments of the invention have been presented for the purposes of illustration and disclosure. It is not intended to be exhaustive or to limit the invention to the precise form disclosed.

Many modifications and variations are possible in light of the above teaching without departing from the spirit and scope of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method for disposing of depleted uranium waste into at least one geologically deep repository, wherein the method comprises steps of:
(a) collecting at least some of the depleted uranium waste; wherein the depleted uranium waste is of at least one of the following different formats: depleted uranium munitions with depleted uranium penetrators; the depleted uranium penetrators without other components of the depleted uranium munitions; solid depleted uranium material; liquid depleted uranium material; or depleted uranium hexafluoride;
(b) preparing the at least some of the depleted uranium waste for disposal into the at least one geologically deep repository; wherein a result of the step (b) is designated as, prepared depleted uranium waste;
wherein when the different format of the at least some of the depleted uranium waste is the depleted uranium munitions with the depleted uranium penetrators, the step (b) comprises separating the depleted uranium penetrators from the other components of the depleted uranium munitions and packaging the depleted uranium penetrators into cylindrical capsules;
wherein when the different format of the at least some of the depleted uranium waste is the depleted uranium penetrators without the other components of the depleted uranium munitions, the step (b) comprises packaging the depleted uranium penetrators into the cylindrical capsules;
wherein when the different format of the at least some of the depleted uranium waste is the solid depleted uranium material, the step (b) comprises forming at least some of the solid depleted uranium material into a slurry;
wherein when the different format of the at least some of the depleted uranium waste is the liquid depleted uranium material, the step (b) comprises converting the liquid depleted uranium material into a solidified depleted uranium product;
wherein when the different format of the at least some of the depleted uranium waste is the depleted uranium hexafluoride, the step (b) comprises converting the depleted uranium hexafluoride into the solidified depleted uranium product;
wherein the prepared depleted uranium waste is one or more of: the depleted uranium penetrators packaged into the cylindrical capsules; the slurry, or the solidified depleted uranium product;
(c) emplacing the prepared depleted uranium waste into the at least one geologically deep repository; and
(d) sealing a wellbore that physically connects to the at least one geologically deep repository;
wherein the at least one geologically deep repository is located in a deep geological rock formation, wherein the deep geological rock formation is located at least 10,000 feet to 30,000 feet below the Earth's surface, plus or minus 1,000 feet.

2. The method according to claim 1, wherein the step (a) is from at least one storage location located on or proximate to the Earth's surface.

3. The method according to claim 2, wherein the at least one storage location is different from a site of the wellbore.

4. The method according to claim 1, wherein after the step (a) the method comprises a step of separating the at least some of the depleted uranium waste that was collected in the step (a) into the different formats.

5. The method according to claim 1, wherein the other components of the depleted uranium munitions, that do not include the depleted uranium penetrators, are not disposed of within the at least one geologically deep repository.

6. The method according to claim 1, wherein after the step (b), wherein with respect to a transverse cross-section through a given cylindrical capsule selected from the cylindrical capsules, at least some of the depleted uranium penetrators are packed concentrically inside with respect to the given cylindrical capsule.

7. The method according to claim 1, wherein the step (b) comprises inserting support dividers between adjacent of the depleted uranium penetrators within the cylindrical capsules; wherein the support dividers are configured to both support and divide the depleted uranium penetrators within the cylindrical capsules; wherein with respect to a transverse cross-section through a given cylindrical capsule selected from the cylindrical capsules, the support dividers are arranged radially, radiating outwards from a center of that given cylindrical capsule.

8. The method according to claim 1, wherein after the step (b), lengths of the depleted uranium penetrators within the cylindrical capsules are substantially parallel with lengths of the cylindrical capsules.

9. The method according to claim 1, wherein the step (b) comprises immobilizing the depleted uranium penetrators within the cylindrical capsules with at least one type of protective medium; wherein the at least one type of protective medium is configured to minimize movement of the depleted uranium penetrators within the cylindrical capsules and to protect the cylindrical capsules from degradation; wherein the at least one type of protective medium occupies the cylindrical capsules filling in void spaces around the depleted uranium penetrators within the cylindrical capsules.

10. The method according to claim 9, wherein the at least one type of protective medium is selected from one or more of: tar; tar-like; bitumen; bitumen-like; asphalt; asphalt-like; heavy hydrocarbons; heavy oils; bentonite clays; vermiculite clays; modified clay nanotube compounds or derivatives thereof; a biocide; an anti-corrosion product; or combinations thereof.

11. The method according to claim 9, wherein the at least one type of protective medium is sterilized before use in the step (b).

12. The method according to claim 1, wherein during and/or after the step (b), the method comprises a step of adding at least one additive to the slurry, wherein the at least one additive is one or more of: a friction reducer, an accelerator, a retarder, an extender, a weighting agent, a fluid loss additive, a scale inhibitor, a lost circulation additive, an expansion additive, a dispersant, an antifoam agent, or combinations thereof.

13. The method according to claim 1, wherein the solidified depleted uranium product is one or more of: metal in billet form; metal in ingot form; sintered shapes of uranium dioxide; aggregate shapes of uranium dioxide; powder of triuranium octoxide; powder of uranium tetrafluoride; powder of uranium trioxide; or powder of uranium dioxide.

14. The method according to claim 1, wherein the step (b) further comprises a step of immobilizing the solidified depleted uranium product by one or more of: cementation, bituminization, vitrification, ceramification, or combinations thereof, with respect to the solidified depleted uranium product.

15. The method according to claim 1, wherein the step (b) further comprises packaging the solidified depleted uranium product into different cylindrical capsules that do not contain the depleted uranium penetrators; wherein the prepared depleted uranium waste comprises the different cylindrical capsules.

16. The method according to claim 15, wherein the solidified depleted uranium product in the different cylindrical capsules is in cementitious form.

17. The method according to claim 1, wherein the at least one geologically deep repository is at least one of: a human-made cavern or a substantially lateral wellbore.

18. The method according to claim 17, wherein the method further comprises a step of forming the human-made cavern or the substantially lateral wellbore before the step (c).

19. The method according to claim 17, wherein during and/or after the step (c), the method comprises a step of filling at least some of the human-made cavern with a supernatant medium that is configured to minimize radionucleotide migration from the prepared depleted uranium waste.

20. The method according to claim 17, wherein the method comprises a step of joining together at least some of the cylindrical capsules via use of couplings to form a string of cylindrical capsules selected from the cylindrical capsules, wherein during the step (c) the string of capsules are loaded into the substantially lateral wellbore, wherein adjacent cylindrical capsules of the string of cylindrical capsules are joined together via a coupling selected from the couplings.

21. The method according to claim 17, wherein prior to the step (c), the method further comprises a step of lining the substantially lateral wellbore with a casing; wherein during the step (c) the cylindrical capsules are emplaced within the casing.

22. The method according to claim 21, wherein the method further comprises a step of pumping cement between the casing and the substantially lateral wellbore; and the method further comprises a step of concentrically centralizing the casing within the substantially lateral wellbore by using centralizers between the casing and the substantially lateral wellbore.

23. The method according to claim 21, wherein the method further comprises a step of pumping a medium between the casing and the cylindrical capsules.

24. The method according to claim 1, wherein the step (c) comprises pumping the slurry into the at least one geologically deep repository through the wellbore.

25. The method according to claim 1, wherein the step (b) occurs at a location that is different from a site where the wellbore is located.

26. A method of disposing of depleted uranium penetrators into at least one geologically deep repository, wherein the method comprises steps of:
(a) collecting depleted uranium penetrators, wherein the depleted uranium penetrators are high density kinetic elements, made substantially from depleted uranium, of depleted uranium munitions;
(b) packing at least some of the depleted uranium penetrators into capsules;
(c) immobilizing the at least some of the depleted uranium penetrators within the capsules; and
(d) emplacing the capsules, with the at least some of the depleted uranium penetrators, into the at least one geologically deep repository, wherein the at least one geologically deep repository is located in a deep geological rock formation, wherein the deep geological rock formation is located at least 10,000 feet to 30,000 feet below the Earth's surface, plus or minus 1,000 feet.

27. The method according to claim 26, wherein the step (a) is from at least one storage location located on or proximate to the Earth's surface.

28. The method according to claim 26, wherein the method further comprises a step of separating the depleted uranium penetrators from other components of the depleted uranium munitions; wherein this separating step occurs after the step (a) and before the step (b).

29. . The method according to claim 28, wherein the other components of the depleted uranium munitions, that do not include the depleted uranium penetrators, are not disposed of within the at least one geologically deep repository.

30. The method according to claim 26, wherein the capsules are substantially cylindrical in shape; wherein after the step (b), wherein with respect to a transverse cross-section through a given capsule selected from the capsules, packed depleted uranium penetrators, selected from the at least some of the depleted uranium penetrators, within that given capsule, are arranged concentrically with respect to the given capsule.

31. The method according to claim 30, wherein the step (b) places support dividers between adjacent of the packed depleted uranium penetrators; wherein the support dividers are configured to both support and divide the packed depleted uranium penetrators within the given capsule; wherein with respect to the transverse cross-section through the given capsule the support dividers are arranged radially, radiating outwards from a center of that given capsule.

32. The method according to claim 26, wherein after the step (b), lengths of the at least some of the depleted uranium penetrators within the capsules are substantially parallel with lengths of the capsules.

33. The method according to claim 26, wherein the step (c) utilizes at least one type of protective medium to immobilize the at least some of the depleted uranium penetrators within the capsules; wherein the at least one type of protective medium is configured to minimize movement of the at least some of the depleted uranium penetrators within the capsules and to protect the capsules from degradation.

34. The method according to claim 33, wherein the at least one type of protective medium is selected from one or more of: tar, tar-like, bitumen, bitumen-like, asphalt, asphalt-like, heavy hydrocarbons, heavy oils, bentonite clays, vermiculite clays, modified clay nanotube compounds or their derivatives, a biocide, an anti-corrosion product, or combinations thereof.

35. The method according to claim 26, wherein the at least one geologically deep repository is at least one of: a human-made cavern or a substantially lateral wellbore.

36. The method according to claim 35, wherein the method further comprises a step of forming the human-made cavern or the substantially lateral wellbore before the step (d).

37. The method according to claim 35, wherein during and/or after the step (d), the method comprises a step of filling at least some of the human-made cavern with a supernatant medium that is configured to minimize radionucleotide migration from the at least some of the depleted uranium penetrators within the capsules; wherein the capsules are dispersed within and covered by the supernatant medium.

38. The method according to claim 35, wherein the method comprises a step of joining together capsules via use of couplings to form a string of capsules selected from the capsules, wherein during the step (d) the string of capsules are loaded into the substantially lateral wellbore, wherein adjacent capsules of the string of capsules are joined together via a coupling selected from the couplings.

39. The method according to claim 35, wherein prior to the step (d), the method further comprises a step of lining the substantially lateral wellbore with a casing; wherein during the step (d) the capsules are emplaced within the casing that is located within the substantially lateral wellbore.

40. The method according to claim 39, wherein the method further comprises a step of pumping cement between the casing and the substantially lateral wellbore; and the method further comprises a step of centralizing the casing within the substantially lateral wellbore by using centralizers between the casing and the substantially lateral wellbore.

41. The method according to claim 39, wherein the method further comprises a step of pumping a medium between the casing and the capsules.

42. The method according to claim 26, wherein after the step (d) the method further comprises a step of sealing the at least one geologically deep repository by plugging a wellbore that leads to the at least one geologically deep repository.
